(19) United States
(12) Patent Application Publication
(10) Pub. No.: US 2017/0145793 A1
(43) Pub. Date: May 25, 2017

(54) Method For Modeling Stimulated Reservoir Properties Resulting From Hydraulic Fracturing In Naturally Fractured Reservoirs

(71) Applicant: FracGeo, LLC, The Woodlands, TX (US)

(72) Inventor: Ahmed Ouenes, Centennial, CO (US)

(73) Assignee: FracGeo, LLC, The Woodlands, TX (US)

(21) Appl. No.: 15/427,698

(22) Filed: Feb. 8, 2017

Related U.S. Application Data
(63) Continuation-in-part of application No. 15/045,861, filed on Feb. 17, 2016.
(60) Provisional application No. 62/294,411, filed on Feb. 12, 2016.
(60) Provisional application No. 62/207,569, filed on Aug. 20, 2015.

(51) Int. Cl. E21B 41/00; E21B 49/00; G06F 17/18; E21B 43/26

(52) U.S. Cl. CPC E21B 41/0092; E21B 43/26; E21B 49/00; G06F 17/18

(57) ABSTRACT

A method for optimizing hydraulic fracturing simulates the geomechanical interaction between regional stress and natural fractures in a reservoir. An equivalent fracture model is created from data on the natural fracture density, regional stress and geomechanical properties of the reservoir, so that points in the reservoir are assigned a fracture length and fracture orientation. The horizontal differential stress and maximum principal stress direction at points in the reservoir are then estimated by meshless particle-based geomechanical simulation using the equivalent fracture model as an input. The meshless particle-based geomechanical simulator uses the derived initial geomechanical condition to simulate the sequence of hydraulic fracturing and derive the resulting strain and J integral that can be used to estimate the asymmetric half fracture lengths and initial propped permeability needed by hydraulic fracturing design and reservoir simulation software to optimize wellbore and completion stage positions.

### RELATED APPLICATION

The present application is based on and claims priority to the Applicant's U.S. Provisional Patent Application 62/294,411, entitled “Method for Modeling Stimulated Reservoir Properties Resulting from Hydraulic Fracturing in Naturally Fractured Reservoirs,” filed on Feb. 12, 2016. The present application is also a continuation-in-part of the Applicant's co-pending U.S. patent application Ser. No. 15/045,861, entitled “System For Hydraulic Fracturing Design And Optimization In Naturally Fractured Reservoirs,” filed on Feb. 17, 2016, which is based on and claims priority to U.S. Provisional Patent Application 62/207,569, filed on Aug. 20, 2015.

### BACKGROUND OF THE INVENTION

Field of the Invention

The present invention relates generally to the field of systems for hydraulic fracturing or refracturing of wells. More specifically, the present invention discloses a system for estimating the strain and its associated permeability resulting from hydraulic fracturing or refracturing and the subsequent pressure depletion around wellbores that can be optimized to increase production, and to reduce drilling and completion costs and the impact of drilling and hydraulic fracturing on the environment by saving water and sand used as proppant. The present invention provide some inputs to common hydraulic fracturing design software to estimate hydraulic fracture asymmetric lengths, heights and conductivity which are combined with outputs of the invention to provide the stimulated permeability to reservoir simulation software. The present invention can also be used in interpreting microseismic surveys or any other direct or indirect measurement used to better understand the stimulated reservoir volume.

Background of the Invention

The statements in this section merely provide background information related to the present disclosure and may not constitute prior art.

Large hydrocarbons resources are locked around the world in unconventional reservoirs such as tight sands, tight carbonates, and shale reservoirs all characterized by an intrinsic very low permeability that does not allow the natural flow of oil or gas to the drilled wellbores. Producing these unconventional hydrocarbons is achieved by primarily hydraulic fracturing which will create artificially the necessary permeability by pumping into the wellbore certain fluids to break the rock and create a complex network of induced fractures.

In a subterranean reservoir, the weight of the overburden and most often tectonic activities gives rise to vertical and horizontal stresses that create natural fractures. In its turn, the resulting natural fracture system along with heterogeneous geomechanical rock properties and variable pore pressure, interacts with the regional stress and create a heterogeneous stress field with locally varying maximum horizontal stress directions. When hydraulic fracturing is initiated in a wellbore in this heterogeneous stress field perturbed by the three sources causing stress gradients, natural fractures, geomechanical rock properties and variable pore pressure, the final permeability that will allow hydrocarbon production depends on the interaction between the induced hydraulic fractures and the pre-existing natural fractures. The potential role played by the natural fractures in the process of hydraulic fracturing and its impact on the hydrocarbon production from the wellbore has been noted by authors in the field. However, the actual modeling of the interactions between hydraulic and natural fractures has been absent in most current hydraulic fracturing design tools.

For many years, hydraulic fracturing was modeled with ideal bi-wing planar fractures that do not interact with any natural fracture. The bi-wing models started with simple 2D models, but have evolved to become pseudo-3D models. Among the multiple deficiencies of current bi-wing hydraulic fracture simulations technologies is their inability to correctly account for fluid leak-off caused by the natural fractures interacting with the hydraulic fractures. To address these shortcomings, various computational methods have been used to model the complex interaction between the induced and natural fractures. These new methods include finite elements, finite difference, boundary elements, block spring model, extended finite element, distinct element method, hybrid finite/discrete elements, and particle methods. Unfortunately, most of these computational methods do not use a realistic description of the natural fractures driven by geophysical and geologic constraints, and do not account for the multitude of stress-related interactions which occur between hydraulic and natural fractures.

As a result the current computational methods taken separately are not able to predict either micro-seismicity, or completion stage performance indicators such as production logs or tracers tests that are validated with real well data. This lack of a mechanistic model that is able to be validated with microseismic and engineering data measuring completion stage performance in real field validations, hampers the ability to solve practical completion optimization problems in wellbores drilled in fractured subterranean reservoirs. Among the deficiencies of the current methods to handle the interaction between hydraulic and natural fractures is their inability to seamlessly input, prior to any simulation of hydraulic fracturing, the proper initial geomechanical conditions that are the result of the interaction between the regional stress and the natural fractures, the heterogeneous rock elastic properties and the pressure depletion of existing wells. These initial conditions are sometimes simulated in other geomechanical software which most frequently do not account for the detailed natural fracture model and its impact on the initial stress field and maximum horizontal stress direction. These proper initial stress conditions play a major role in any realistic simulation of the hydraulic fracturing where the interaction between hydraulic and natural fractures are accounted for. This lack of accurate and realistic modeling of the hydraulic fracturing that must take into account the presence of natural fractures, heterogeneous geomechanical properties and pore pressure, affects hydraulic fracturing design software that are used to devise the best treatment that achieves the best hydraulic fracture height and length. Most of the hydraulic fracturing design software do not account for the complex interaction between the hydraulic and natural fractures thus provide along the wellbore similar designs and pumping treatments which results in simplistic symmetric bi-wing hydraulic fractures that are not supported by field measurements such as microseismic data. Furthermore, the resulting initial propped permeability derived from the hydraulic fracture design is limited to the simplistic symmetric hydraulic fracture plane which does not cover the stimulated reservoir volume needed by the reservoir simulation software that will help estimate the extent of the pressure depletion resulting from the production. As a result of these technical challenges, conventional modeling technologies and software have been unable to provide the necessary information needed by completion and reservoir engineers in a very short time frame of few hours to selectively place their wellbores and completion stages in a way that leads to the highest hydrocarbon production while reducing the costs and the environmental impact to the strict minimum. Based on extensive data from many unconventional wells drilled in North America, it has been estimated that 40% of the unconventional wells are uneconomical due to the poor positioning of the drilled wellbores and poor selection of the completion stages. One possible cause of the poor placement of the wellbores and completion stages is the unavailability of technologies that allow the rapid identification and mapping of geomechanical sweet spots where the wells should be drilled and completion stages selected. Providing a means for estimating the asymmetric half-lengths and the initial propped permeability in a subterranean formation would assist in defining and mapping these geomechanical sweet spots and the resulting extent of pressure depletion which will allow optimal selection of well spacing and refracturing candidates.

Until recently, hydraulic fracturing design was not able to take into account the complex interaction between hydraulic fractures and a realistic distribution of the natural fractures that creates stress gradients along and around the wellbores. Hence, most of the hydraulic fracturing designs assume symmetric bi-wing fractures and the same concept is extended to reservoir simulation where a constant propped permeability is assumed to be present in a symmetric rectangular area around each stimulation stage of the wellbore. Another approach is needed to estimate the asymmetric half-length at each stimulation stage and its result on the variable propped permeability found in the irregularly shaped stimulated reservoir volume. To accomplish this goal, the present invention uses other methods that could provide the asymmetric half fracture length for hydraulic fracturing design software and the subsequent variable initial propped permeability needed by reservoir simulation software to estimate the extent of the pressure depletion around the wellbore.

Prior-art approaches have used microseismic data to estimate the asymmetric hydraulic fracture half-length and the irregularly shaped initial propped permeability in the stimulated reservoir volume. Unfortunately, the number of wells that have microseismic data is very limited and estimated to be 2% or less, making this approach to capture the asymmetric behavior not economical since it will be too costly to conduct a microseismic survey on every well. An alternative method to quickly compute the asymmetric half lengths and subsequent initial propped permeability in few hours instead of days or weeks is provided in the present methodology.

Accordingly, there remains a need for developing a robust workflow that combines in a mechanistic model the simultaneous use of geology, geophysics and geomechanics, devices, and systems for the estimation of the hydraulic fracture half lengths for hydraulic fracture design software and distribution of initial propped permeability and the subsequent pressure depletion for completion optimization in fractured subterranean reservoirs to increase hydrocarbon production, reduce drilling and completion costs and reduce the impact on the environment by saving water and sand used as proppant.

### SUMMARY OF THE INVENTION

This invention provides a system for optimizing hydraulic fracturing in naturally-fractured reservoirs by optimizing the position of wellbores and hydraulic fracturing stages to increase production, reduce drilling and completion costs and impact on the environment. Geologic, geophysical and engineering data is initially gathered and processed to estimate the distribution of the natural fractures and the reservoir geomechanical properties. Stress data is gathered and processed utilizing the derived distribution of natural fractures and geomechanical properties in a meshless particle-based geomechanical simulator to simulate the geomechanical interaction between the regional stress and the natural fractures, heterogeneous geomechanical properties and variable pore pressure to estimate horizontal differential stress and maximum principal stress directions which both represents the initial geomechanical conditions present prior to the hydraulic fracturing. The meshless particle-based geomechanical simulator can use as input an explicit 2D or 3D description of the natural fractures. The initial geomechanical results include the computation of the horizontal differential stress maps and local maximum principal stresses directions. The meshless particle-based geomechanical simulator uses the derived initial geomechanical condition to add hydraulic fractures and apply pressure on their faces to simulate the sequence of hydraulic fracturing and derive the resulting strain and J integral which can be used to estimate the asymmetric half-lengths and initial propped permeability needed by hydraulic fracturing design and reservoir simulation software to optimize wellbore and completion stage positions that achieve the highest production in the stimulated reservoir volume and that allow a better interpretation of microseismic surveys or any other field measurement used to achieve similar goals.

Further, in some embodiments, the strain from the meshless particle-based geomechanical simulator is used to validate an interpreted acquired microseismic survey or any other field measurement used to achieve similar goals, and then used in any other wellbore to predict the microseismicity expected if the well is hydraulically fractured. The strain derived from the meshless geomechanical simulator can also be interpreted to derive the asymmetric half-lengths needed to input in hydraulic fracturing design software to match the treatment data of a hydraulically fractured well to estimate the fracture height and stress gradients at each stimulation stage. The strain derived from the meshless geomechanical simulator when combined with the estimated fracture height from the hydraulic fracture design software can also be related to initial propped rock permeability in the vicinity of the hydraulically fractured wellbore and can be used as an input in a reservoir simulator to match the production and pressure history of a hydraulically fractured well.

A major feature of the present invention is its ability to first combine the continuous representation of the natural fractures as a 2D map or a 3D volume derived from multiple sources that is then transformed into an equivalent fracture model where natural fractures or faults are represented by segments of certain lengths and orientations, which are used as input into a meshless particle-based geomechanical simulator able to represent explicitly the natural fractures or faults. Another major feature is the ability to model in the meshless particle-based method the interaction between the regional stress with the equivalent fracture model to quickly yield (i.e., in only few hours) horizontal differential stress maps and local maximum principal stresses directions, which can be used as the proper initial geomechanical conditions present before hydraulic fracturing. The meshless particle-based geomechanical simulator able to represent explicitly the natural fractures with the proper derived initial geomechanical conditions is used to add explicitly hydraulic fractures which are pressurized to reproduce the stress effects, and its propagation in the continuum reservoir, created during a hydraulic fracturing operations. The resulting strain is used to interpret geomechanical asymmetric half-lengths that can be input as a constraint into hydraulic fracturing design software to estimate the fracture heights and stress gradient at each stimulation stage. Altogether, the derived strain and estimated half lengths and fracture heights are used to estimate an initial propped permeability that will show the extent of the pressure depletion thus allowing the selection of optimal wellbore trajectories and completion stages that will increase production from unconventional wells, reduce drilling and completion costs and reduce the impact of drilling and hydraulic fracturing on the environment by saving water and sand used as proppant.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a diagrammatic representation of a cross section in a pad drilling where four horizontal wellbores are drilled in different directions and in different fractured subterranean reservoirs from one single pad.

FIG. 2 is a diagrammatic representation of an aerial view of a pad drilling where multiple pads each with multiple horizontal wellbores are drilled in different directions.

FIG. 3 is a diagrammatic representation of multiple completion stages interaction with natural fractures in a fractured subterranean reservoirs along a horizontal wellbore.

FIG. 4 is a diagrammatic representation of multiple asymmetric half-lengths hydraulic fractures.

FIGS. 5a and 5b are flowcharts of a method for hydraulic fracturing design and optimization based on the use of strain to estimate geomechanical half-lengths and stimulated permeability for reservoir simulators, in accordance with the present invention.

FIGS. 6a and 6b are flowcharts illustrating aspects of the estimation of a natural fracture model step of the method illustrated in the flow chart of FIGS. 5a-5b.

FIG. 7 is a diagram showing a template of nine values used to compute the length and orientation of natural fractures from a 2D scalar map.

FIG. 8 is a diagram showing an explicit representation of a natural or hydraulic fracture in the material point method.

FIG. 9 is a diagram showing a 2D map of a seismic proxy for a natural fracture distribution around a well that has nine hydraulically fractured stages.

FIG. 10 is a diagram showing an Equivalent Fracture Model (EFM) with the regional stress applied on it.

FIG. 11 is a diagram showing the description of the natural fractures in a meshless particle-based method and the application of the regional stress as a boundary condition.

FIG. 12 is a diagram showing the horizontal differential stress map.

FIG. 13 is a diagram showing the strain around the stimulated well with its interpreted microseismicity.

FIG. 14 is a diagram showing the strain around the stimulated well with a cross-section of the same well and the interpreted tracer tests along all nine stimulation stages.

FIG. 15 is a diagram showing the strain map along with the interpreted geomechanical asymmetric half lengths for each of the nine stimulation stages.

FIGS. 16a and 16b are diagrams showing the estimated half-lengths and fracture heights estimated in a hydraulic fracture design software using as a constraint the geomechanical half lengths

FIG. 17 is a diagram showing the strain volume derived by combining the estimated fracture heights and half lengths.

FIG. 18 is a diagram showing the history match of the well performance

FIG. 19 is a diagram showing the resulting initial propped permeability

FIG. 20 is a diagram showing the resulting pressure depletion which affected mainly the last five stimulation stages towards the heel of the well thus pointing to the need to refracture the first four stimulation stages at the toe of the well that did not cause major pressure depletion as a result of the initial hydraulic fracturing treatment

FIGS. 21a and 21b are flowcharts of a method for hydraulic fracturing design and optimization based on the use of the strain, its resulting geomechanical half lengths and initial stimulated permeability represented as a volume or approximated by multiple planar asymmetric hydraulic fractures

### DETAILED DESCRIPTION OF THE INVENTION

For the purposes of promoting an understanding of the principles of the present invention, reference will now be made to the embodiments illustrated in the drawings, and specific language will be used to describe the same. It is nevertheless understood that no limitation to the scope of the disclosure is intended. Any alterations and further modifications to the described methods, devices, and systems, and any further application of the principles of the present disclosure are fully contemplated and included within the present disclosure as would normally occur to one skilled in the art to which the disclosure relates. In particular, it is fully contemplated that the steps, features or components described with respect to one embodiment may be combined with the steps, features or components described with respect to other embodiments of the present invention. For the sake of brevity, however, the numerous iterations of these combinations will not be described separately.

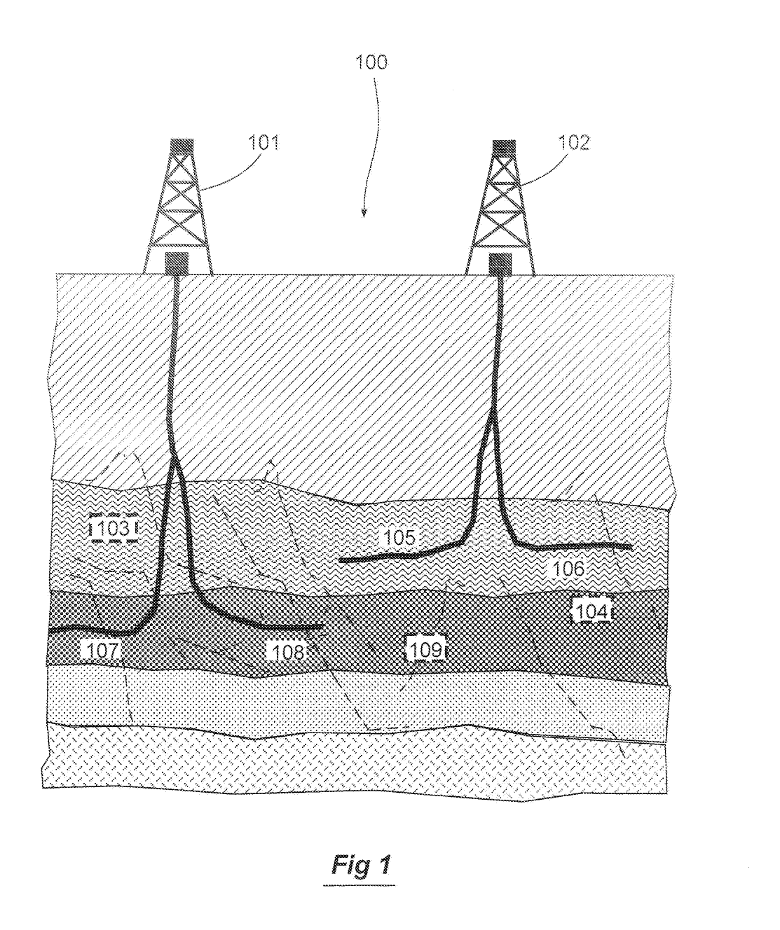

Referring initially to FIG. 1, a cross-section 100 is shown extending across two well surface locations 101 and 102. The surface location 101 has two horizontal wellbores 107 and 108 drilled in the fractured subterranean reservoir 104 and another surface location 102 has two other horizontal wells 105 and 106 drilled in another fractured subterranean reservoir 103. The regions 104 and 103 may include a natural fracture network 109 that extends through one or more subterranean geologic formations.

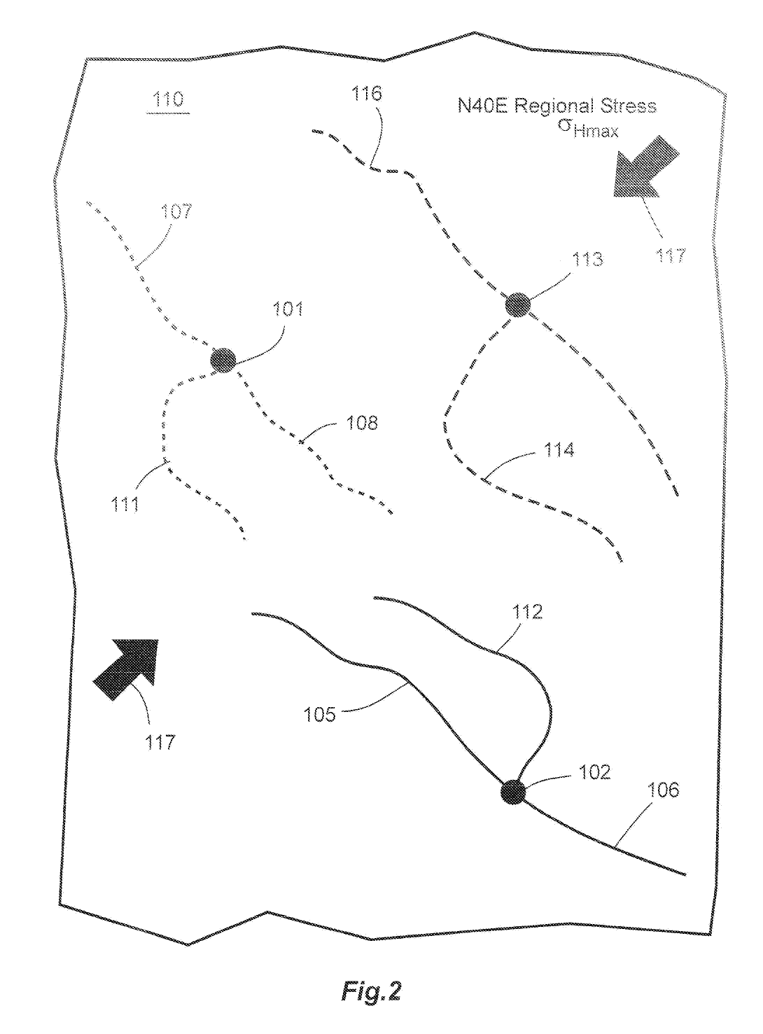

Generally, the cross-section 100 is representative of any type of field 110 shown in FIG. 2 where natural resources are obtained. In some particular instances, the field 110 is an oil field, natural gas field, geothermal field or other natural resources field where multiple surfaces locations 101, 102 and 113 are used to drill vertical wells or multiple horizontal wellbores 105, 106, 107, 108, 111, 112, 114, 115, and 116. The horizontal wellbores are frequently drilled in the direction perpendicular to the regional maximum horizontal stress direction 117 (as shown in FIG. 2) to allow for the development of transverse hydraulic fractures that will grow from the wellbore and in the direction of the maximum horizontal stress 117. In this regard, FIG. 2 shows the location of completed and stimulated horizontal wells 105 (each showing a continuous line for the completed and stimulated wellbore), and the location of drilled but not completed wells 107 (each showing a semi-dashed line for the drilled but not completed wellbore) and the location of undrilled wells 115 (each showing a dotted line for the undrilled wellbore) in a field 110. As will be discussed below, in some instances data regarding the drilled and not completed wells 107 and drilled and completed wells 105 is utilized in different steps of the workflow to estimate different geomechanical results that could be used to optimize the recompletion and ref racturing of drilled and completed wells 105, optimize the completion of drilled wells 107 and optimize the drilling and completion of undrilled wells 115

Surface seismic data can be available or not in the field 110. If available, the surface seismic data can be combined with well data to delimit the boundaries of regions 104 and 103 as well as provide information on the dynamic geomechanical properties, the in-situ stress, and the reservoir fluids that affect the propagation of seismic waves in the regions 104 and 103. The following description will primarily focus on the design and completion optimization of vertical, deviated and horizontal wells by using the strain results derived from the geomechanical simulation of hydraulic fracturing and their subsequent use to estimate hydraulic half fracture lengths and heights which will combined with the strain to estimate the initial stimulated permeability, a critical input for reservoir simulation.

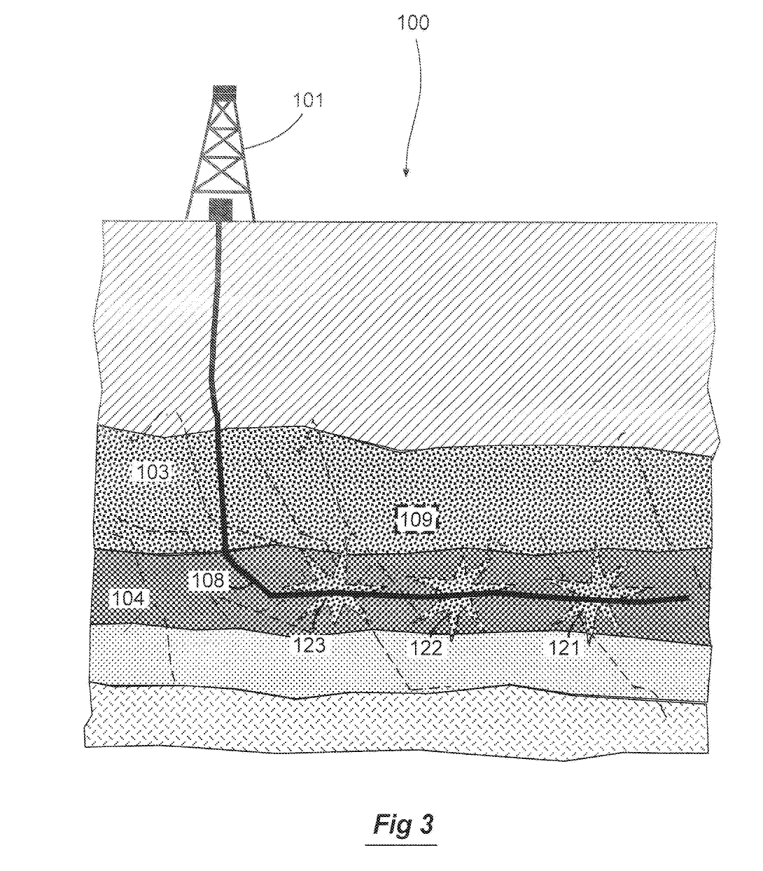

FIG. 3 shows a wellbore 108 that has been drilled, but not completed and stimulated, crossing a fractured subterranean region 104. Multiple logs measuring rock properties are computed or measured along wellbore 108 and can be used in the completion optimization process. Wellbore geometry and various logs computed or measured along the wellbore 108 provide stress information that could be used in the workflow. In some implementations, the well 101 is used to apply an injection treatment to extract resources from the subterranean formation 104 through the wellbore 108. The example well 101 may be used to create a complex hydraulic fracture 121 in wellbore 108. Properties of the injection treatment can be calculated or selected based on computer simulations of complex hydraulic fracture 121 propagation and interaction with the natural fracture network 109 in the subterranean region 104. The spacing between hydraulic fractures 121 and 122, can be optimized to find the best well performance using net present value or any other economic criteria to evaluate the financial impact of the various completion strategies.

During the hydraulic fracturing of wellbore 108, geophones or other types of listening equipment placed inside existing wellbores, at the surface or beneath it can be used to sense microseismic or similar information. During and after the hydraulic fracturing, other measurements which include production logs, tracers, and fiber optics can be collected along wellbore 108 to quantify the efficiency of hydraulic fracture stage 121 and to estimate its contribution to the overall production coming from wellbore 108.

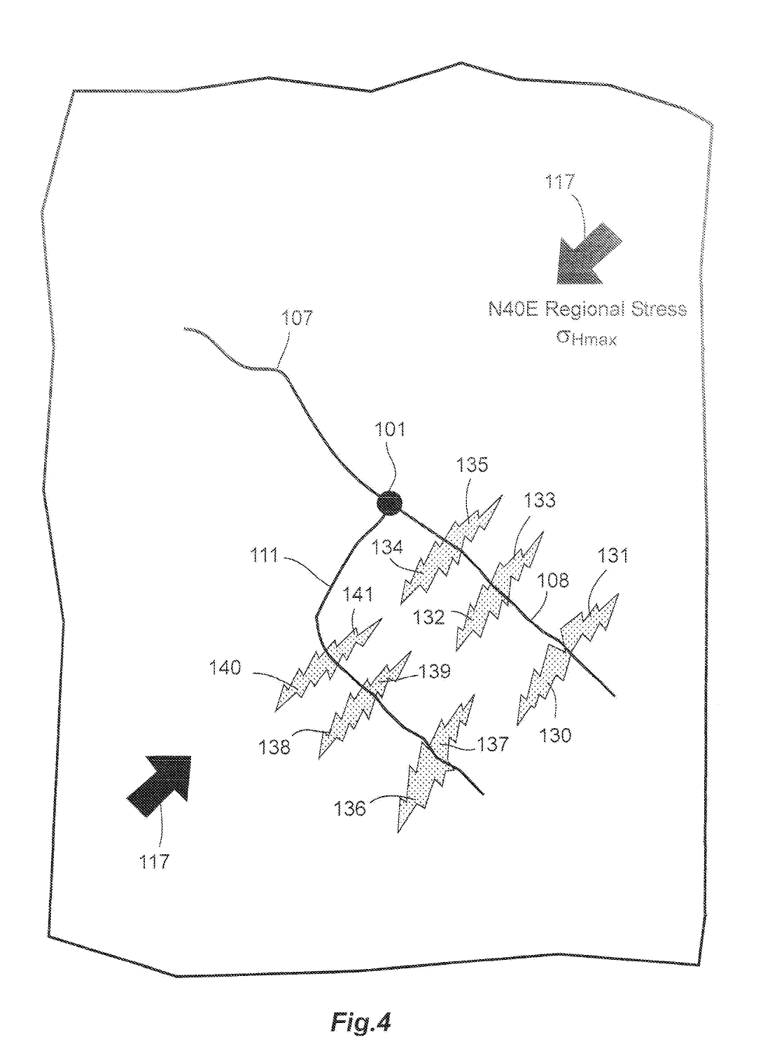

FIG. 4 shows the stimulation of wellbores 108 and 111 with three hydraulic fracturing stages. As will be discussed below, in some instances the workflow will provide the results needed to estimate the optimal number of hydraulic fracturing stages needed for optimal stimulation of wellbores 108 and 111. Properties of the injection treatment can be accomplished in a manner that allows for a controlled hydraulic fracturing sequence to optimize the stimulated volume between wellbores 108 and 111. The sequence of hydraulic fracturing could sequentially treat wellbore 108 by executing frac stage 121 followed by frac stage 122 and finally frac stage 123. The hydraulic fracturing of wellbore 108 will lead to asymmetric and variable half fracture lengths 130 and 131 at hydraulic fracture stage 121, an asymmetric and variable half fracture lengths 132 and 133 at hydraulic fracture stage 122, and an asymmetric and variable half fracture lengths 134 and 135 at hydraulic fracture stage 123. Once the stimulation of wellbore 108 is completed, the sequential fracing of wellbore 111 is initiated by executing a sequence of completion stages. In other implementations, the sequence of hydraulic fracturing could be parallel or simultaneous and treat wellbores 108 and 111 simultaneously by executing completion stages 121 in wellbore 108 and a first frac stage in wellbore 111. The next sequence will execute simultaneously completion stages 122 in wellbore 108 and a second frac stage in wellbore 111. The final sequence will execute simultaneously completion stages 123 in wellbore 108 and a third completion stage in wellbore 111. Alternatively, the sequence of hydraulic fracturing could be a “zipper” and alternate between wellbores 108 to 111.

Depending on the hydraulic fracturing sequence executed on wellbores 108 and 111, the hydraulic fracturing of wellbore 108 will lead to an asymmetric and variable half fracture lengths 130 and 131 at hydraulic fracture stage 121, followed by asymmetric and variable half-fracture lengths 132 and 133 at hydraulic fracture stage 122, and an asymmetric and variable half-fracture lengths 134 and 135 at hydraulic fracture stage 123. For the wellbore 111, the asymmetric and variable half-fracture lengths of the first fracture stage will be 136 and 137, the asymmetric and variable half-fracture lengths of the second fracture stage will be 138 and 139, and the asymmetric and variable half-fracture lengths of the third fracture stage will be 140 and 141.

These asymmetric and variable half-fracture lengths are a mathematical discretization of the complex region of stimulated rock volume created by the hydraulic fracturing but they are commonly used in hydraulic fracturing design and reservoir simulation software, which commonly assume these half-fracture lengths to be symmetric, perpendicular to the wellbores and having a constant length across the wellbore. Another assumption commonly made is the orientation of the hydraulic fracture being always in the direction of the maximum horizontal stress direction 117. Unfortunately, the geologic and stress conditions of the subterranean reservoir exhibit large heterogeneities and stress gradients that cause an asymmetric and variable half-fracture length that is not always oriented in the direction of the maximum horizontal stress direction 117 as revealed through microseismic data.

In addition to the variability of rock geomechanical properties and reservoir pore pressure, a major geologic factor creating these stress variations and gradients is the presence of the natural fractures system 109 that interacts with the regional stress and its maximum horizontal stress direction 117.

The objective of the present invention is to provide a reliable and rapid way to evaluate the asymmetric half lengths used in hydraulic fracturing design and reservoir simulation as well as the initial stimulated permeability that could be used in a reservoir simulator to evaluate the extent of the depletion zone where the hydraulic stimulation will be the most effective and lead to the best and largest hydrocarbon recovery factor. These asymmetric half lengths and stimulated permeability could be identified by estimating the geomechanical strain in each subterranean fractured formation 103 and 104 across the field 110. The present invention provides a new way to estimate quickly the initial geomechanical conditions resulting from the interaction between the natural fracture system 109 and the regional stress and its maximum horizontal stress direction 117. The present invention uses these initial geomechanical conditions as input in the simulation of the hydraulic fracturing and the resulting interaction between the hydraulic and natural fractures which lead to a complex distribution of the strain around the stimulated well. The derived strain map or 3D volume could be validated with microseismic interpretations or performance indicators measured at stimulation stages. Having the strain map or 3D volume, an operator will be able to estimate the asymmetric half lengths at each stimulation stage that can be used to constrain the hydraulic fracturing design software which will provide a more accurate estimation of the hydraulic fracture height, the stress gradients and other key treatment parameters needed to optimize the hydraulic fracturing of each stage to the surrounding geologic and geomechanical conditions present at the time of the hydraulic fracturing. These engineered completion stages will help the operator ensure the successful hydraulic fracturing of a limited number of completion stages thus providing the highest potential hydrocarbon production while keeping the costs of completion to the strict minimum by saving on water and sand used during the hydraulic fracturing process.

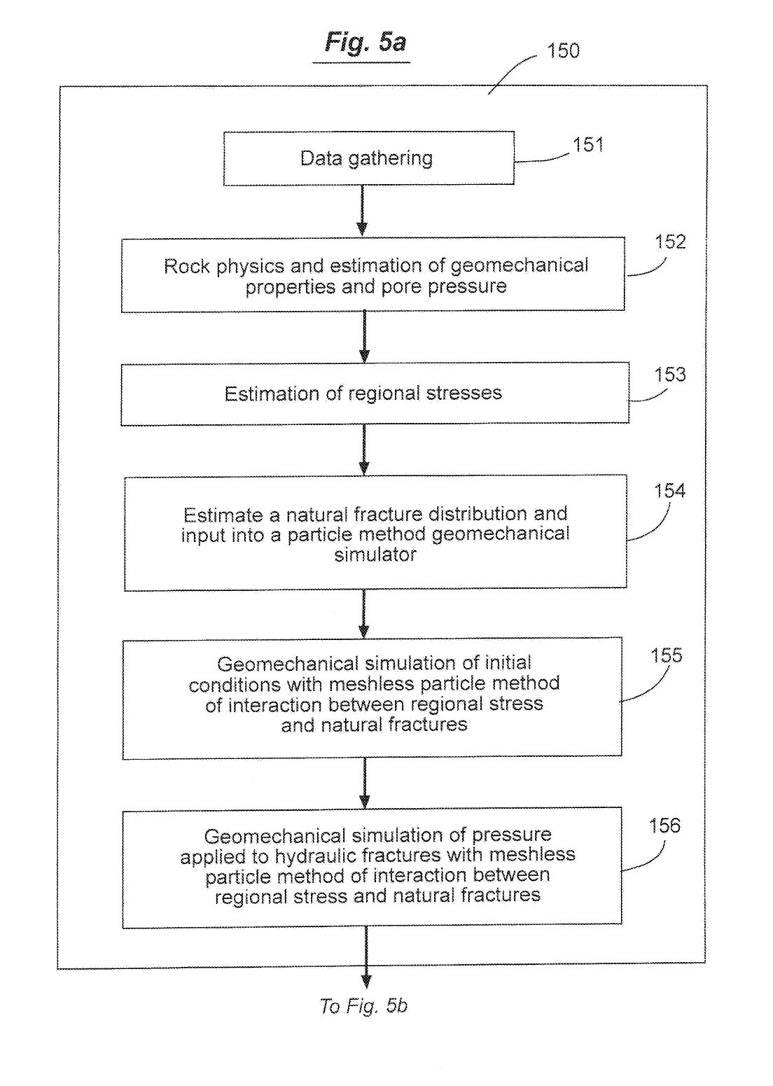

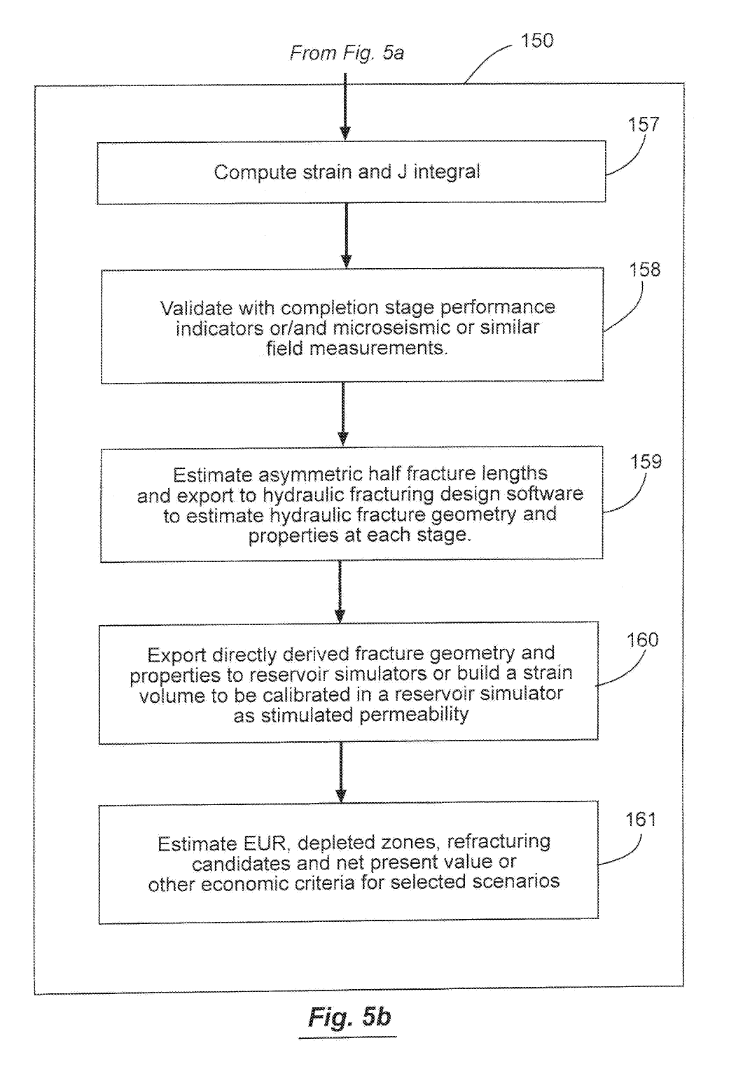

FIGS. 5a-5b are flowcharts of an exemplary method of hydraulic fracture design and completion optimization according to the present invention. In this regard, the method will be described with respect to various steps. Generally, the present invention aims to optimize hydraulic stimulation and wellbore completion designs prior to drilling and hydraulic fracturing of new wells through the use of a new geomechanical simulation and data typically available during field development (seismic, well data). The process involves multiple steps including data gathering, rock physics and estimation of geomechanical properties and pore pressure, regional stress estimation, natural fracture modeling, geomechanical simulation of initial geomechanical conditions resulting from the interaction between the regional stress with natural fractures, computation of strain and the J integral, validation with field data if available, estimation of asymmetric half lengths to be exported to hydraulic fracturing design that will provide the asymmetric hydraulic fracture geometry and its properties, export the derived fracture geometry directly to reservoir simulators, or combine the derived strain and estimated fracture geometry to build a strain volume to be correlated to stimulated permeability used in any reservoir simulation software, and to use the multiple results to estimate the Estimated Ultimate Recovery (EUR), completion stages spacing, well spacing in a pad, and refracturing candidate. The data used is comprised of data such as well locations, drilling, logging, completion, fracturing, seismic, microseismic or similar information, and production data. A major advantage of the present invention is the ability to use a continuous fracture model to create an equivalent fracture model that will be used as input into a meshless particle-based geomechanical model to quickly simulate (i.e., in few hours) the initial geomechanical conditions resulting from the interaction between the regional stress and the natural fractures represented by the equivalent fracture model, as well as the interaction of the hydraulic fractures and natural fractures during the hydraulic fracturing. The resulting outputs of the present invention include the strain which can be used to estimate the asymmetric geomechanical half lengths needed as constraints by the hydraulic fracturing design software whose hydraulic fracture geometry results could be exported directly to reservoir simulators or combined with the volumetric strain to estimate the initial stimulated permeability needed by reservoir simulation software. These improved reservoir simulation inputs help optimize the position of the wellbores and hydraulic fractures to produce the highest production of hydrocarbons while keeping the drilling and completions costs to a minimum and reducing the impact on the environment by avoiding using excessive water and sand on completion stages that will not successfully produce hydrocarbon.

Data gathering is an important part of the method as many of the subsequent steps and analysis depend on the data gathered in step 151 of FIG. 5a. To this end, data can be extracted from a variety of available sources. Examples of the various types of data that are commonly utilized will be described below, however, no limitation is intended. Rather, it is understood that the present invention can utilize essentially any type of information related to a field/reservoir or wells that can be quantified in some manner. Accordingly, one of ordinary skill in the art will recognize that extension of the present invention to types of data not explicitly described within the present disclosure is still within the scope of the present invention. Further, it is understood that data may come in various types of file formats, including imported data from proprietary databases found in commercial software, open databases, spread sheets, .pdf files, text files, ASCII files (e.g., LAS files designed for well logs), xml files, SEGY files (e.g., special ASCII files designed for seismic data) or combinations thereof. In this regard, it is also understood that the file formats include both common file formats and proprietary file formats. Generally, data obtained from any type of format may be utilized within the methods and systems of the present invention. Those of ordinary skill in the art will recognize that some file conversion or other processes are implemented in some instances to allow for the proper processing of the data from the various file formats within the context of the present disclosure. Accordingly, the details of such conversions and processing will not be described in detail herein.

In some instances, the data gathering step 151 includes gathering or obtaining well locations and deviations, and reservoir properties estimated from drilling data or wireline logs such as gamma ray, density, resistivity, neutron, compressional and shear sonic, and image logs such as FMI, FMS, petrophysical interpretations leading to the estimation of porosity, water saturation, and core data providing measurement of total organic carbon (TOC), porosity, permeability, and fracture density. In some instances the data gathering includes geologic reports, geologic formations tops and 3D geocellular grids that will allow the identification of the boundaries of the geologic formations 103 and 104 in the wellbores. The 3D grids could be imported from existing reservoir modeling software or constructed using the geologic formations tops available in the existing wells, wireline logs, and seismic data and its interpretation if available.

In some instances, the data gathering step 151 includes gathering or obtaining seismic data and seismic attributes. The seismic data could be post-stack or pre-stack, and the seismic attributes could be derived from a multitude of post stack and pre-stack processes that include seismic resolution enhancement or bandwidth extension methods that allow the seismic signal to reach higher frequencies, seismic structural attributes such as coherency, similarity, volumetric curvature or any other seismic method that uses these seismic attributes to image faults and fractures, spectral decomposition methods that provide frequency dependent seismic attributes or any seismic attribute that combines multiple spectral attributes, post stack seismic inversion methods such as colored inversion, deterministic inversion, sparse spike inversion, generalized linear inversion, stochastic or geostatistical inversion, pre-stack seismic inversion methods such as Extended Elastic Inversion, simultaneous pre-stack inversion, AVO methods, azimuthal anisotropy methods, shear wave velocity anisotropy methods, isotropic and anisotropic velocity models and all other seismic methods that use seismic data to provide information over a large reservoir volume that includes one or multiple wells.

In some instances, the data gathering step 151 includes gathering or obtaining drilling reports and measurements, such as rate of penetration, mud losses and information derived from mud logs such as total gas, gas chromatography measurements. Mud losses and gas chromatography measurements are commonly available data and could be utilized as a proxy of fracture density when there are no wireline, image logs and core data. When no logs are available, surface or downhole drilling data could be used to derive geomechanical logs, pore pressure, stresses and natural fractures.

In some instances, the data gathering step 151 includes gathering or obtaining completion stimulation data. The completion data includes the position and depth of the perforation clusters, cluster per fracture stages, tubing size, completion time. The stimulation data includes treatment volumes and rates, completion stages, initial and final instantaneous shut-in pressure (ISIP), breakdown pressure, closure pressure, conductivity, fracture gradient or other information regarding stimulation.

In some instances, the data gathering step 151 includes gathering or obtaining microseismic, tiltmeter data, or any similar measurements and their interpretation, which could provide some indication on the geometry of the hydraulic fracture, direction of localized maximum horizontal stress, and in some instances information on the failure mechanisms and the orientation of the critically stressed natural fractures. In the proposed workflow to estimate initial geomechanical conditions, it is desirable to validate the predicted results by using interpreted and correctly positioned microseismic, tiltmeter data and events or any similar type of information.

In some instances, the data gathering step 151 includes gathering or obtaining hydraulic fracture stage performance indicators such as production logs, tracer tests, fiber optics, that provide quantitative or qualitative information on the performance of each hydraulic fracture stage. In the proposed workflow to estimate initial geomechanical conditions, it is desirable to validate the predicted results by using one or multiple data that could be considered a fracture stage performance indicator.

In some instances, the data gathering step 151 includes gathering or obtaining well production rate and pressure, such as oil, water, and gas production rates, cumulative productions, estimated ultimate recovery, initial production of the first 30, 90 and 180 days, pressure and production decline parameters. These production and pressure data could be used in multiple ways including validation of the derived predicted results of workflow as well as natural fracture density proxy if there are no available drilling data, wireline and image logs, petrophysical interpretation or core data to quantify the natural fractures at the wells. These production and pressure data are the result of the interaction of three major factors and their interaction resulting from the drilling, completion and stimulation of the considered well. These three factors are first the geologic heritage and the resulting resource represented by the rock porosity and the total organic carbon (TOC), second the plumbing or permeability created during the stimulation which depends in large part on the rock brittleness and the natural fractures, and third on the drilling, completion and stimulation design. The first two factors can be optimized by finding the geologic sweet spots where the best rock property that has the best combination of porosity, TOC, rock brittleness and natural fractures can be found. The third factor depends in big part on the geomechanical sweet spots where the horizontal differential stress is low and the localized maximum principal stress direction is perpendicular to the drilled wellbore. The workflow provides the geomechanical sweet spots which represents the initial geomechanical conditions that could be used to optimize the drilling, completion and stimulation design to achieve the highest well production while keeping the cost as low as possible by avoiding drilling and stimulating poor rock that will not produce.

In some instances, as part of the data gathering step 151, the collected data is processed to fit the needs of the subsequent steps of the method in FIGS. 5a-5b. For example, many data types require quality control steps to remove noise and outliers that could introduce errors in the subsequent modeling steps of the method in FIGS. 5a-5b. The outcome of the data gathering process 151 and the quality control applied to a data set that will include one or multiple wells that will have varying data collected during and after drilling, completion and stimulation as well as in some instances volumetric information represented by seismic, microseismic or tiltmeter data that provide information over a large area around one or multiple wells.

Returning to FIG. 5a, with the data gathered at step 151, the method continues at step 152 with rock physics and estimation of geomechanical properties and pore pressure. In this step, the objective is to estimate the static geomechanical properties needed for the geomechanical modeling which include the Poisson's Ratio, Young's Modulus and density. In some instances the wireline and image logs, petrophysics interpretation, core data is not available at all or is available only in a limited number of wells. When the wireline logs and core data is not available in any well, step 152 can use published data or wireline log data from analogue fields or nearby wells until log data becomes available in the field 110. If the compression, shear sonic and density logs are available in wells 101 and 102, the dynamic geomechanical properties such as Young's Modulus and Poisson's Ratio are computed using established geophysical relationships. If static measurements of the geomechanical properties made in laboratory tests conducted on reservoir rocks are available, the dynamic geomechanical properties derived from the geophysical logs could be calibrated to the static measurements and used in the next steps of method in FIGS. 5a-5b. If the laboratory static measurements of the geomechanical properties are not available, then drilling data could be used to derived the geomechanical logs. If no wireline or drilling data are available to compute the key geomechanical logs, published correlations or nearby well data could be used to estimate the adjustment factor needed to multiply the dynamic elastic properties.

The geomechanical properties derived at the wells 101 and 102 need to be propagated in the entire subterranean formation 104 and 103. This could be accomplished by using well data alone, or combining the available well data with seismic data, if available. If no seismic data is available, the geomechanical properties available in the wells 101, 102 and other possible wells in the field 110, could be distributed in the subterranean formations using deterministic, geostatistical, neural networks, or any other reservoir modeling method. When seismic data is available, it could be used to derive the distribution of the elastic properties in multiple ways. When pre-stack seismic is available, it can be used in pre-stack elastic inversion to derive directly the seismically derived compressional and shear velocity along with an estimate of the density which are then combined to form the seismically derived dynamic geomechanical properties. These dynamic geomechanical properties are adjusted to static measurements using the same procedure described for the adjustments applied to the elastic properties derived from well logs. If pre-stack seismic is not available, post stack seismic attributes could be used to guide the geostatistical or neural network based interpolation in the subterranean formation 104 and 103 of the elastic properties derived at wells 101, 102 and other possible wells in the field 110.

Referring again to FIG. 5a, with the data gathered at step 151, the geomechanical properties estimated in the entire subterranean formations 104 and 103, the present method continues at step 153 with the estimation of the regional stresses. In this step, the objective is to estimate the vertical stress, the pore pressure and the magnitude and orientation of the regional horizontal stresses in field 101. This estimation depends on the available data in the field 101 or in nearby fields. For example, the different methods that can be used to compute these stresses and the data needed for each method are described in detail in the book by Mark Zoback entitled “Reservoir Geomechanics”, from Cambridge University Press (2010). A variety of conventional techniques for estimating these stresses and data are known in the industry. New methods using only surface or downhole drilling data are making this critical information readily available in all the wells.

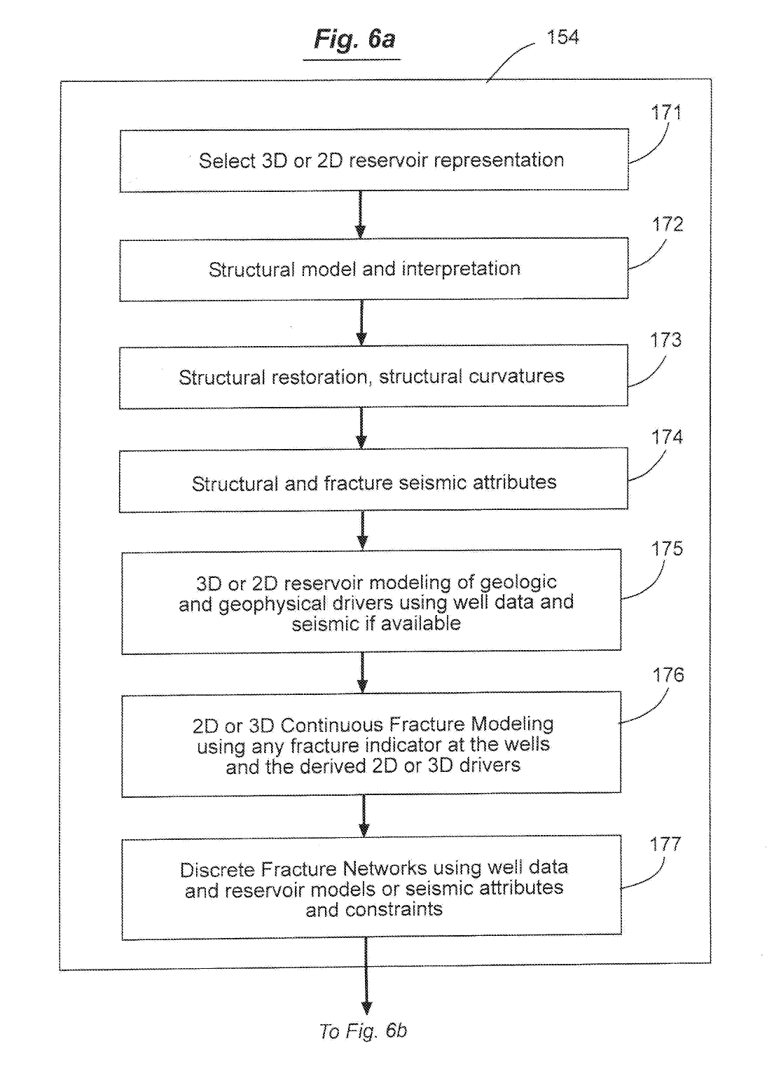

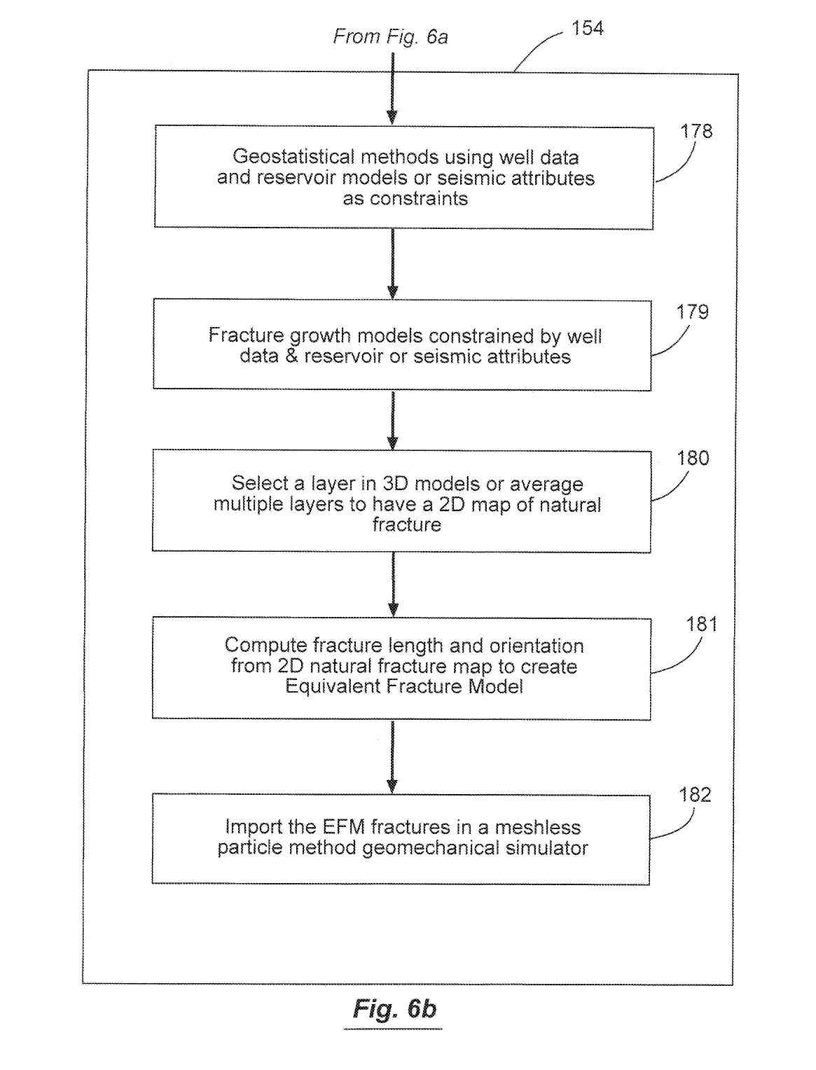

Referring again to FIG. 5a, the present method continues at step 154 with the estimation of the natural fracture distribution shown in detail in FIGS. 6a-6b. Since the natural fracture distribution is a key component of the invention, multiple methods can be used to determine the best natural fracture distribution possible given a set of available data. The process for finding the natural fractures, for example, in the naturally fractured subterranean formation 103, starts by selecting a three dimensional or two dimensional representation 171 of the considered reservoir volume. When using a three dimensional representation, the natural fractures could be represented by discrete planes or by an average characteristic of the natural fractures, such as fracture density, in a representative elementary volume. When using a two dimensional representation of the reservoir volume, the natural fracture density is approximated at a surface location 102 or 101 by an average value, such as hydrocarbon production rates, that could be used as a proxy for the combined effects of the complex three dimensional fracture network 109. When using either a three dimensional or two dimensional representation of the reservoir, the boundaries of the naturally fractured subterranean formation 103 can be represented by the structural model that includes the interpreted geologic boundaries derived by using seismic data or geologic reports and well tops.

Multiple methods can be used in this invention to determine the natural fracture distribution. The methods involve the use of one or more types of data and could require one or more processing steps. Among the methods that require minimal data and processes, the tectonics methods use the structural surfaces and their deformation to infer a fracture density that is assumed to be high where the structural geologic surface is highly deformed. The degree of deformation of the geologic surface is measured by computing the curvature on the current geologic structural surface or by the amount of strain generated while deforming a flat surface until it takes the shape of the current geologic structural surface. These methods through structural restoration and structural curvatures 173 could provide a distribution of the natural fractures in certain tectonics regimes but they are approximations that in some situations do not provide a realistic distribution of the natural fractures

Another method that provide fracture proxies in certain particular situations is the use of certain seismic algorithms applied to seismic data to provide structural or fracture seismic attributes 174. The structural seismic processing methods use the dip in the seismic data to compute the curvature, or compare the presence or absence of correlation between multiple nearby seismic traces. All the structural seismic attributes and the methods used to derive them from seismic data are described in great detail in the book by Chopra S. and K. Marfurt, entitled “Seismic Attributes For Prospect Identification and Reservoir Characterization,” published by the Society of Exploration Geophysicists and European Association of Geoscientists and Engineers (2007). Examples of seismic processing algorithms that attempt to image directly the natural fractures are described in great detail in the book by Liu, E. and Martinez, A., entitled “Seismic Fracture Characterization”, published by EAGE Publications by (2013). When fracture information from well data is not available or not sufficient and only seismic data is available, the present invention can use the structural seismic attributes as a proxy for the distribution of the natural fractures.

One method that is able to derive a 2D or 3D distribution of the natural fractures relies on the use of geologic and geophysical drivers which represent reservoir properties that are known to impact the degree of natural fracturing. For example, brittle reservoirs tend to have more fractures than ductile rocks that could deform without breaking and creating fractures. In addition to brittleness of the rock, the thickness of the fractured subterranean formation 103 is another well recognized fracture driver whereas thinner parts will have more natural fractures than thicker parts. In this context, the estimation of the natural fractures as a continuous property derived in the entire 2D or 3D study area requires the estimation of the geologic and geophysical drivers that could be computed directly from seismic data, or estimated in 2D or 3D by combining the available well logs and core data with the available seismic data and derived seismic attributes. This estimation of the continuous fracture drivers in the entire 2D or 3D study area can be achieved by using the existing deterministic interpolation methods, geostatistical methods, neural networks or any other reservoir modeling method able to propagate the limited well data in the entire 2D or 3D study area.

Once the geologic and geophysical drivers are available over the 2D or 3D study area, the natural fracture density available at the wells and measured from wireline and image logs, petrophysical interpretations and core data, from drilling reports, or from well production can be propagated to create a continuous natural fracture density defined in the entire 2D or 3D study area by using artificial intelligence tools such as neural network in the methodology described by Ouenes, A., “Practical Application of Fuzzy Logic and Neural Networks to Fractured Reservoir Characterization,” Computer and Geosciences, 26, 953-962 (2000). This artificial intelligence workflow will find the geologic relationship that relates the continuous drivers available in the entire study area with the natural fracture defined in a 3D representation along the wellbores 105, 106 or in a 2D representation at the well locations such as 101 and 102. Once this geologic relationship is found and validated with existing well data, it will be applied over the entire study area to predict the continuous natural fracture density or its proxy defined using wireline logs, surface or downhole drilling data, drilling reports measurements such as mud losses, or well performance derived from well production.

Referring again to FIG. 6a, the method 154 continues at step 177 where the natural fracture could be represented by discrete fracture planes and estimated using a statistical method that uses the available fracture statistics available at the wells. The discrete fracture network will attempt to honor the fracture statistics available at the wells as well as a continuous natural fracture property such as the one derived in step 176 or a seismic structural attribute 174 to guide the distribution of the discrete fracture network as described in Ouenes, A., and Hartley, L. J., “Integrated Fractured Reservoir Modeling Using Both Discrete and Continuum Approaches,” Society of Petroleum Engineers. doi:10.2118/62939-MS (2000).

Referring again to FIG. 6b, the method 154 continues at step 178 where the natural fracture model could be distributed in the 2D or 3D study area using geostatistical methods that rely mainly on the natural fracture statistical information derived at the wells as illustrated by J.-P. Chiles, “Fractal and Geostatistical Methods For Modeling Of A Fracture Network,” Mathematical Geology, 20(6):631-654 (1988). The geostatistical methods used to distribute the natural fractures could be constrained by additional information such as seismic data as illustrated by Liu, X., Srinivasan, S., and Wong, D., “Geological Characterization Of Naturally Fractured Reservoirs Using Multiple Point Geostatistics,” Society of Petroleum Engineers. doi:10.2118/75246-MS (2002).

Referring again to FIG. 6b, the method 154 continues at step 179 where the natural fracture model could be derived with a growth model as shown by Olson, J. E, “Joint Pattern Development: Effects Of Subcritical Crack Growth And Mechanical Crack Interaction,” Journal of Geophysical Research, 1993, Volume 98, Issue B7, p. 12251-12265. These growth models could also be combined with geostatistical methods and discrete fracture networks as illustrated by Bonneau, F., Henrion, V., Caumon, G., Renard, P., Sausse, J., “A Methodology For Pseudo-Genetic Stochastic Modeling Of Discrete Fracture Networks,” Computers & Geosciences, 2013, 56, 12.

Referring again to FIG. 6b, the method 154 continues at step 180 where the 3D natural fracture model defined in a continuous way in step 176 or approximated with a structural seismic attribute 174, or estimated from structural restoration resulting strain or a structural curvature 173 needs to be extracted along a structural horizon close enough to the wellbore 108, or averaged in an interval encompassing the wellbore 108 and inside the subterranean formation 103. The resulting averaging process or selection along a structural horizon will lead to the availability of a 2D map of natural fracture density or one of its proxies. In a 3D problem, multiple 2D maps are extracted at different depths and used sequentially in the proposed invention to create a 3D volume of differential stress.

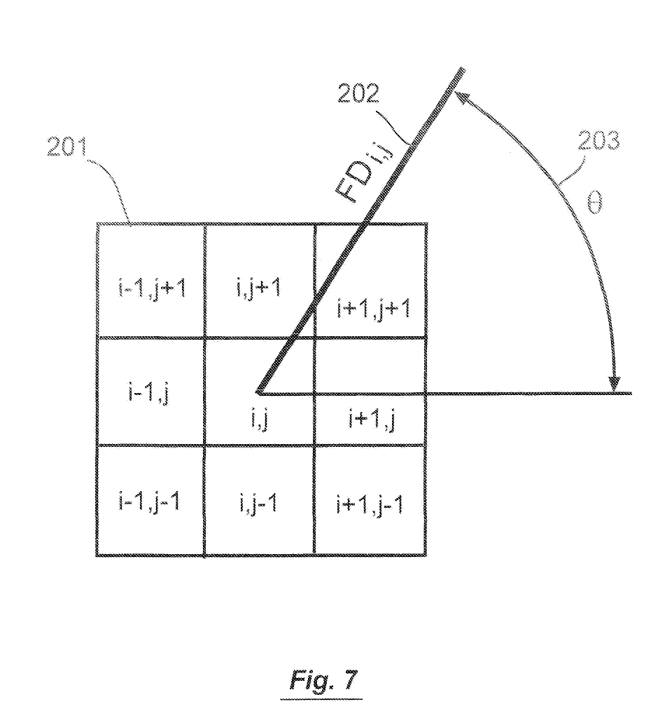

Referring again to FIG. 6b, the method 154 continues at step 181 where the continuous scalar 2D map natural fracture model derived in step 180 is converted to an equivalent fracture model representing a vectorial map where at each location on the map will have a fracture length and fracture orientation computed using either the weighting method described by Zellou, A. M., Ouenes, A., and Banik, A. K., “Improved Fractured Reservoir Characterization Using Neural Networks,” Geomechanics and 3-D Seismic., Society of Petroleum Engineers. doi:10.2118/30722-MS (1995, Jan. 1) or any other method described by Fisher N., I., “Statistical Analysis Of Circular Data,” Cambridge University Press (1996). This step 181 is one of the fundamental elements of the present invention, wherein any 2D map scalar representation of the distribution of the natural fractures density or any proxy that could represent natural fracture density is converted to a set of connected or disconnected fracture segments that have a certain length and orientation. Given the importance of this step in the present invention, the details of this step are illustrated by using the weighting method, but any other circular statistical method could be used to achieve the same goal of transforming a scalar 2D map of fracture density into an equivalent fracture model made of fracture segments characterized by a length and an orientation. Referring to FIG. 7, the weighting method is illustrated by considering a subset of a 2D grid centered on the cell (i,j) and divided into discrete cells labeled by their coordinates i and j 201, where the fracture density at cell (i,j) is labeled FD (i,j) is represented by a segment which has a length L(i,j) 202 and an angle theta (i,j) 203. The length L(i,j) could be given by the formula:

L(i,j)=1.5 pow[10×(FD(i,j)/max FD(i,j))]

Where max FD(i,j) represents the maximum value of the fracture density in the entire 2D grid. The angle theta (i,j) of the equivalent fracture is given by the formula:

Theta(i,j)=Arcsin {F(i,j)/sqrt [F(i,j)*F(i,j)+E(i,j)*E(i,j)]}

Where E(i,j)=A (i,j)*0.707+B(i,j) and F(i,j)=C (i,j)*0.707+D(i,j) Where:

A(i,j)=FD(i+1,j+1)−FD(i−1,j−1)+FD(i+1,j−1)−FD(i−1,j+1)

B(i,j)=FD(i+1,j)−FD(i−1,j)

C(i,j)=FD(i+1,j+1)−FD(i−1,j−1)+FD(i−1,j+1)−FD(i+1,j−1)

D(i,j)=FD(i,j+1)−FD(i,j−1)

Referring again to FIG. 6b, the method 154 continues at step 181 with the 3D natural fracture model. If a discrete fracture network 177 or fracture growth model 179 was used to generate the natural fracture distribution in 3D, the 2D natural map is found by taking the intersection between the structural horizon close to the wellbore 108 with the 3D discrete natural fracture model. The resulting intersection provide the equivalent fracture model needed for the next step 182 where the natural fracture information is input in a meshless particle-based geomechanical simulator.

Referring again to FIG. 6b, the method 154 continues at step 182 where the equivalent fracture model is used to convert the natural fracture segments derived in the equivalent fracture model into particles that will be used in a meshless particle-based method such as the material point method or any similar particle method. The explicit discretization of a segment representing a natural fracture into particles is illustrated by Nairn, J. A., “Material Point Method Calculations with Explicit Cracks,” Computer Modeling in Engineering & Science, 4, 649-66, 2003. Since the use of a meshless particle-based geomechanical simulator and its ability to use as input the derived equivalent fracture is a key element of the present invention, more details are given on a particular particle-based method called the Material Point Method (MPM) and the publicly-available software that can be used to implement the invention.

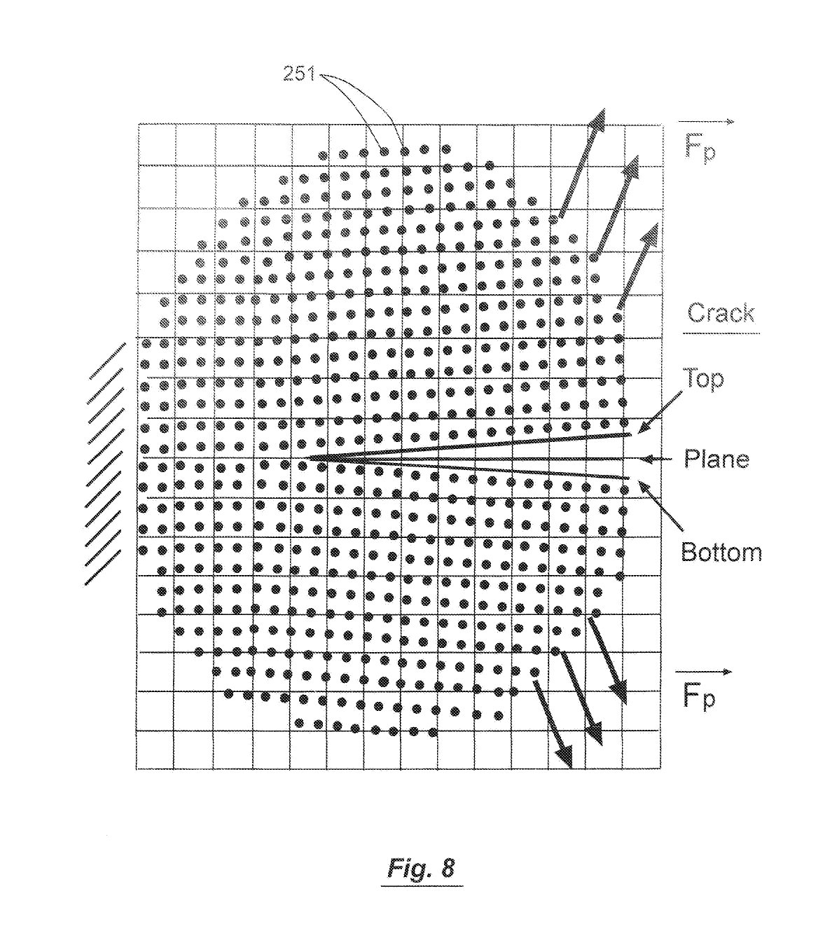

The Material Point Method (MPM) is a meshless method developed by Sulsky, D., Z. Chen, and H. L. Schreyer, “A Particle Method For History-Dependent Materials,” Computer Methods in Applied Mechanics and Engineering, 118, 179-196 (1994), as a potential tool for numerical modeling of dynamic solid mechanics problems. It represents an alternate approach, with alternate characteristics, for solving problems traditionally studied by dynamic finite element methods. In MPM, a material body is discretized into a collection of points 251, called particles as shown in FIG. 8. A background grid is associated with the particles; it is composed of cells. Solid body boundary conditions are applied to the grid or on the particles. The background grid is only used as a calculation tool space for solving the equations of motion. At each time step, the particle information is extrapolated to the background grid, to solve these equations. Once the equations are solved, the grid-based solution is used to update all particle properties such as position, velocity, acceleration, stress and strain, state variables, etc. This combination of Lagrangian (particles) and Eulerian (grid) methods has proven useful for solving solid mechanics problems. It has been shown to be especially useful for solving problems with large strains or rotations and involving materials with history-dependent properties such as plasticity or viscoelasticity effects.

One potential application of MPM is dynamic fracture modeling as shown by Nairn, J. A., “Material Point Method Calculations with Explicit Cracks”. Computer Modeling in Engineering & Science, 4, 649-66, 2003. To handle explicit fractures such as the ones developed with the equivalent fracture model, MPM was extended by Nairn using the CRAMP (CRAcks in the Material Point) algorithm. Both the particle nature and the meshless nature of MPM makes CRAMP well suited to the analysis of problems in fractured media. In 2D MPM, fractures are represented by a series of line segments as computed in the equivalent fracture model. The endpoints of the line segments are massless material points, called fracture particles. By translating the fracture particles along with the solution, it is possible to track fractures in deformed or translated bodies. The fracture particles also track crack-opening displacements that allow for calculation of fracture surface movements. The fracture particles influence the velocity fields on the nearby nodes in the background grid. In addition, CRAMP fully accounts for fracture surface contact, is able to model fractures with frictional contact, can use fractures to model imperfect interfaces, and can insert traction laws to model cohesive zones, or input pressure.

The CRAMP algorithm models displacement discontinuities in fractured media by allowing each node near the fracture to have two velocity fields representing particles above and below the fracture as shown in FIG. 8. The disclosure uses the publically available MPM software Nairn-MPM-FEA that can be downloaded from https://code.google.com/p/nairn-mpm-fea.

Although the particle method is the preferred technique to do the geomechanical simulation of the effect of the regional stress on the natural fractures, it should be understood that other techniques could be employed. Possible alternative geomechanical methods include finite elements, finite difference, extended finite elements, or any discretization scheme suitable for solving continuum mechanics equations.

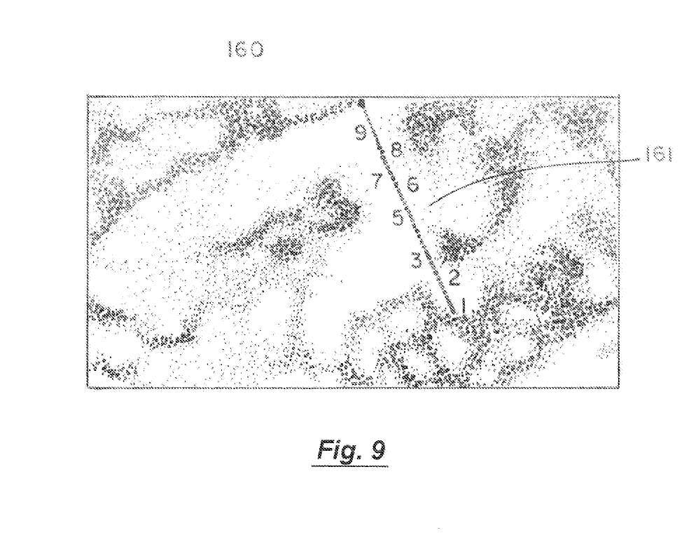

Referring again to FIG. 5a, with the natural fracture distribution completed and the resulting equivalent fracture model discretized into particles and input into a meshless particle-based geomechanical simulator, the method continues at step 155 where the interaction between the derived regional stress 153 and the natural fracture distribution 154 will be simulated. The disclosed methods are described using information from an actual shale reservoir. The area that was selected as part of this study is located in Texas and the target fractured subterranean formation is the Eagle Ford shale. One of the major characteristics of this study is the availability of a seismic attribute called the coherency that could be used as natural fracture proxy. A well 161 shown in FIG. 9 is the focus of the study. The well 161 is completed with nine hydraulic fracturing stages in the Eagle Ford. Microseismic data 204 was acquired to monitor the stimulation across the nine stages. Tracer tests 254 provided the contribution of each frac stage. The maximum horizontal stress direction 117 is the northeast direction and the stress anisotropy (defined as the maximum horizontal stress divided by the minimum horizontal stress) of 1.2 was assumed in the study area. The seismic attribute called coherency map was used as a proxy for the natural fractures. This seismic attribute map was published by Suliman, B., Meek, R., Hull, R., Bello, H., Portis, D., & Richmond, P. (2013, Aug. 12). Variable Stimulated Reservoir Volume (SRV) Simulation: Eagle Ford Shale Case Study. Society of Petroleum Engineers. doi:10.1190/URTEC2013-057. The coherency map 160 is shown in FIG. 9.

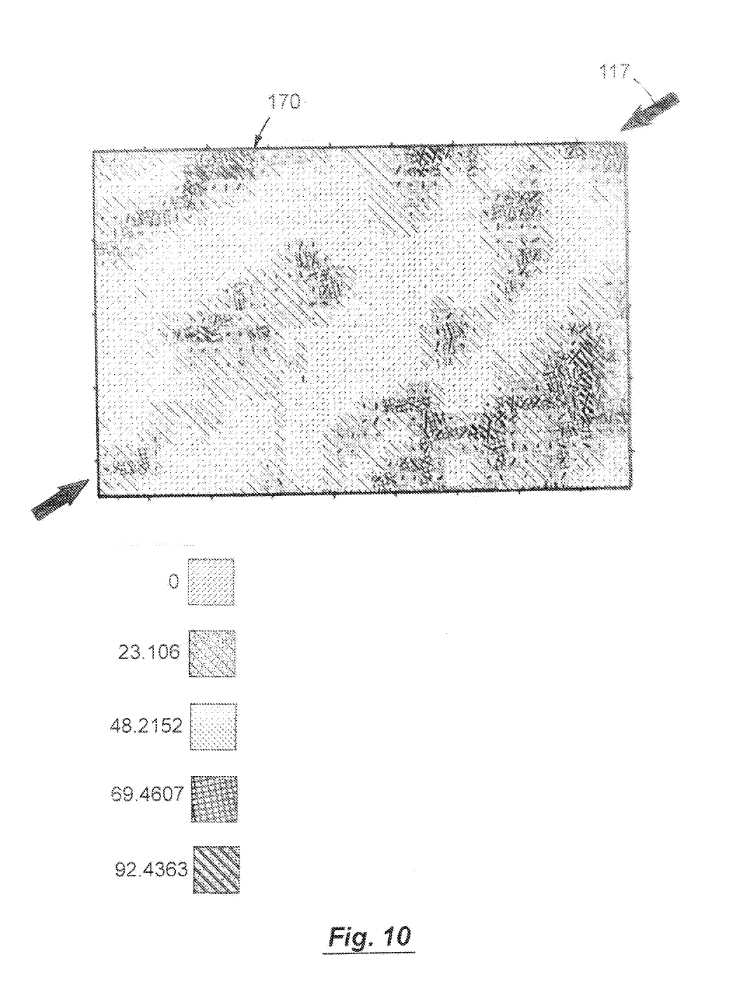

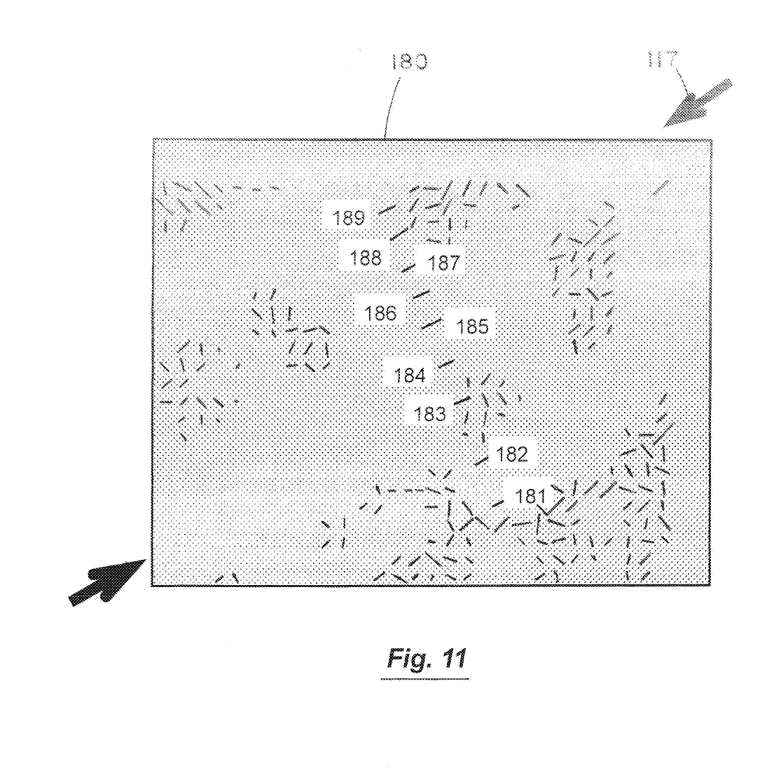

Referring to FIG. 9, we will assume that the coherency map 160 is a seismic attribute 174 (FIG. 6a), that could be a reasonable proxy for natural fracture density distribution 154. Applying the methods described in FIG. 6b in step 181, the coherency map is converted into an equivalent fracture model 170 as shown in FIG. 10. The regional stress 117 will be applied to the equivalent fracture model 170. The resulting equivalent fracture model 170 where each natural fracture is represented by a length and orientation is imported in a particle-based geomechanical simulator able to discretize the natural fractures into particles 180 as shown in FIG. 11.

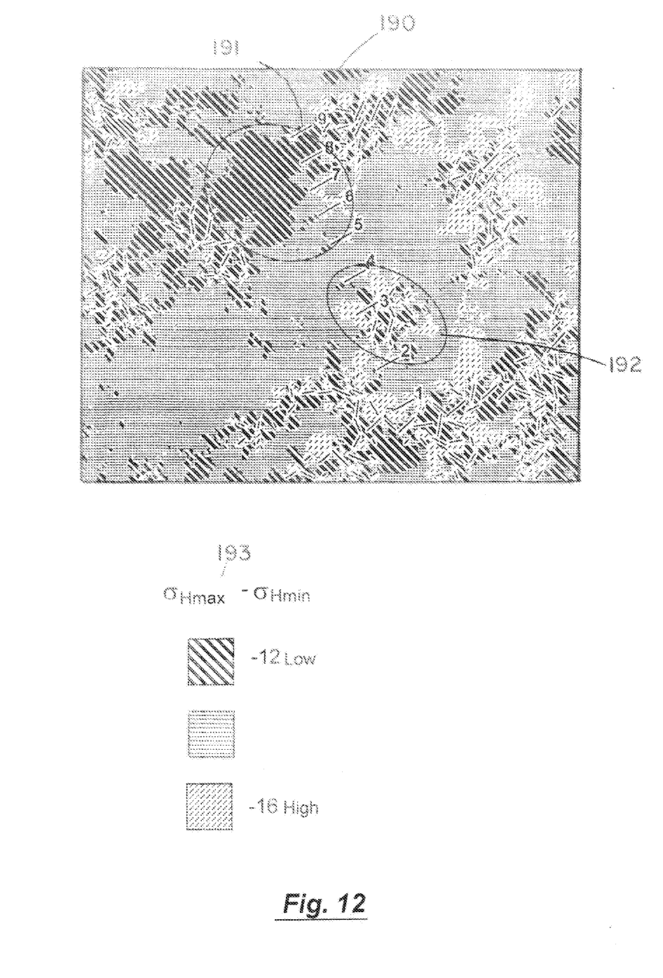

Referring to FIG. 5a, the equivalent fracture model 170 is input in the meshless particle-based geomechanical simulation, the method 150 continues at step 155 to compute the initial geomechanical conditions resulting from the interaction between the regional stress 117 and the equivalent fracture model 170. These initial geomechanical conditions are represented by a horizontal differential stress 190 as shown in FIG. 12 and the maximum principal stress direction. The geomechanical simulator outputs the differential stress 190 which represents the difference between SHmax, the maximum horizontal stress and SHmin the minimum horizontal stress computed as shown in FIG. 12. The resulting differential stress map 190 shows areas in black 191 where the differential stress is low thus helping the development of hydraulic fracturing complexity that is frequently responsible for successful hydraulic fracturing. The area 192 shows an area colored mainly in white where the differential stress is high thus could lead to poor stimulation if the stimulation treatment across all the stages is the same and not adapted to the variable differential stress

The particle-based geomechanical simulator uses the 2D plane strain theory to solve numerically the momentum equation in the presence of the regional stress 117 representing the main boundary condition. Poroelasticity is included in the geomechanical modeling to handle variable pore pressure and its impact on the hydraulic fracturing. The regional stress boundary conditions 117 are applied to the study area 180 by simulating the compression over a time period that is sufficient to achieve quasi-equilibrium. An example of particle-based geomechanical simulator is described by Aimene, Y. E., and Nairn, J. A., “Modeling Multiple Hydraulic Fractures Interacting with Natural Fractures Using the Material Point Method,” Society of Petroleum Engineers. doi:10.2118/167801-MS (2014, Feb. 25).

Referring again to FIG. 5a, with the initial geomechanical conditions 155 completed, the method continues at step 156 where the hydraulic fracturing will be simulated by including interaction between the derived hydraulic fractures 181, 182, 183, 184, 185, 186, 187, 188, and 189 and the natural fracture distribution captured by the equivalent fracture model 180. The hydraulic fracturing simulation consists of applying, at a certain time interval, a pressure on the faces of each hydraulic fracture 181. The time interval and the order of the hydraulic fracturing is determined by the sequence of hydraulic fracturing executed in the real field conditions. The pressure applied on each hydraulic fracture is provided by the operator or derived from the pumping rates measured during the hydraulic fracturing. The hydraulic fractures 181 could be set to an average half-length and pressure applied to their faces or could be set to a small value and the hydraulic fracturing simulation could include their propagation. In the considered example propagation of the hydraulic fracture was turned off and a given half-length was set from the beginning of the simulation.

The particle-based geomechanical simulator used to compute the initial geomechanical conditions is also used to simulate the hydraulic fracturing process by using the 2D plane strain theory to solve numerically the momentum equation in the presence of the regional stress 117 and the pressure applied to each hydraulic fracture face. The particle-based geomechanical simulator referenced earlier in Aimene, Y. E., and Nairn, J. A., “Modeling Multiple Hydraulic Fractures Interacting with Natural Fractures Using the Material Point Method,” Society of Petroleum Engineers. doi:10.2118/167801-MS (2014, Feb. 25), could be used for the hydraulic fracturing simulation also.

After all the hydraulic fractures were pressurized, multiple geomechanical results could be derived. Referring again to FIGS. 5a-5b, with the hydraulic fracturing simulation 156 completed, the method continues at step 157 where multiple physical quantities involved in the continuum mechanics, like displacement, strain and stress fields are computed while including poroelasticity effects due to variable pore pressure caused by depleted wells. These continuum mechanics computations take into account the displacement or geometrical discontinuities and stress concentration at the crack tip involved in fractured media by using fracture mechanics model that provides an estimation of the rate of energy release available at the unit area of the crack surface, the J integral, that could control the material failure. These results provide two valuables properties that could be used to validate the geomechanical model and its input. The first output is the strain 203 computed in the y direction that very often provides a direct indication of the microseismic response or similar information measured during or after hydraulic fracturing. The second property is the J integral which in some cases is related to the performance of the completion stage. In the considered invention we use common fracture mechanics theories where the main focus is the analysis of the stress field in the fractured media. To characterize the stress concentration around the fracture tip, and to predict fracture propagation, we consider a global approach based on the balance of energies involved in the process of fracture growth. The energy available to create an increase in the fracture length is the energy release rate G. The fracture grows when the energy release rate, G is greater than or equal to a critical value, toughness G_{c}, which is a material property. This invention uses 2D plane strain elastic theory which is used to study the lateral effects of hydraulic fracturing in the presence of natural fractures. In this setting, the J integral represents the energy release rate G.

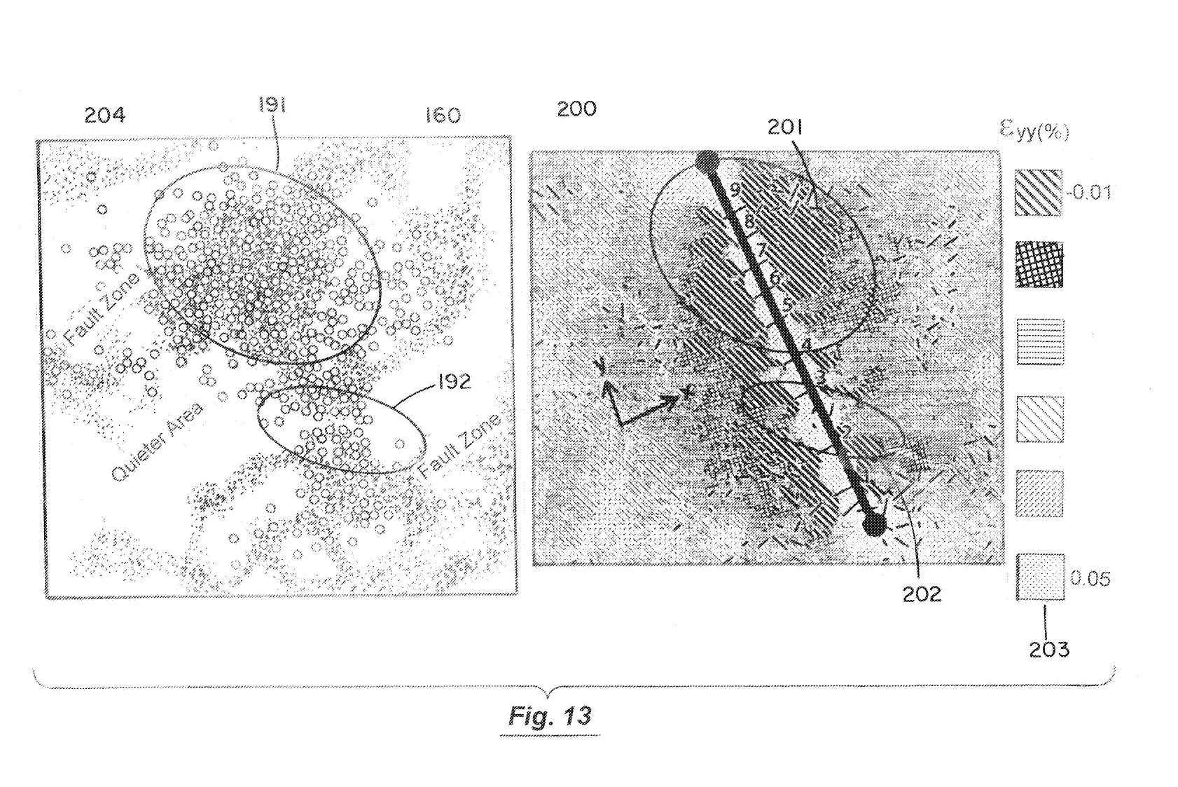

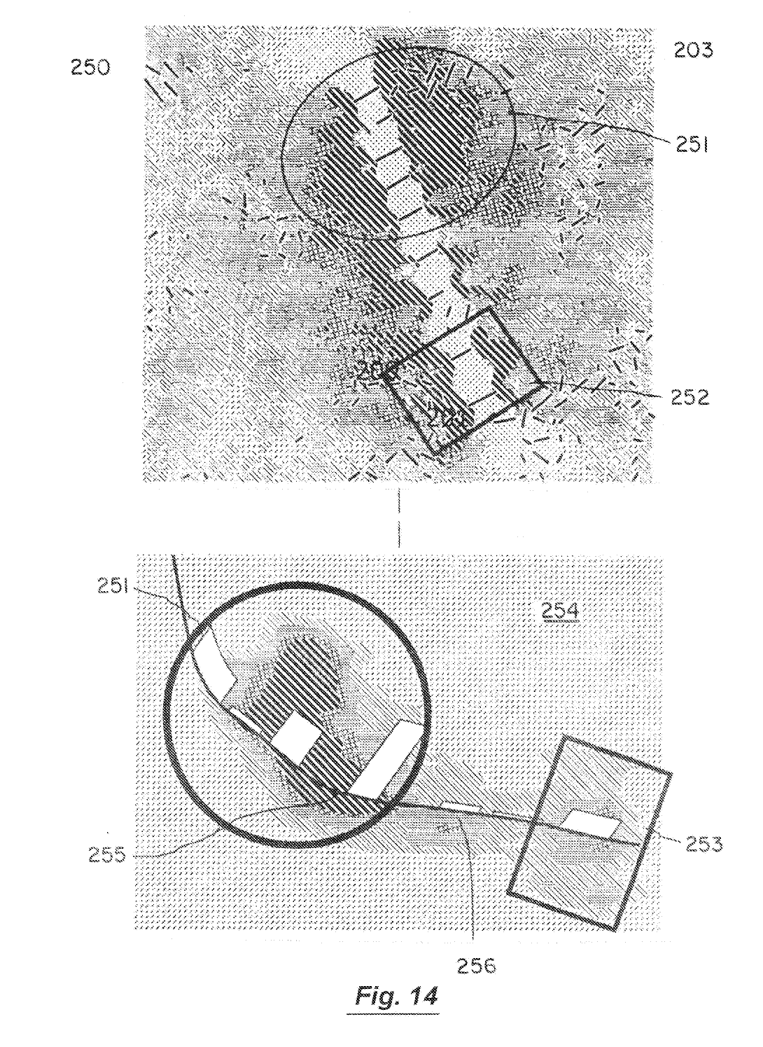

Referring again to FIG. 5b, with the strain and J integral computed, the method continues at step 158 where these results are validated against some field data. Referring to FIG. 13, the strain map 203 is compared to the available microseismic data 204 which shows an area 191 with a dense microseismicity and another area 192 with almost no microseismic events. This lack of microseismic events in area 192 coincides with the low values of strain in area 202. The area 201 where high strain values are found corresponds well with the high density microseismic events found in area 191. Referring to FIG. 14, the strain map 203 is compared to the available microseismic data density 254 represented across the wellbore in a cross section. The area 251 where high strain values are found in the strain map 203 are compared to high microseismic density observed in the cross section 254. Similar conclusions are derived when considering the area 252 of the strain map 203 which also shows low microseismic density in the cross section 254. In addition to validation with microseismic density, tracer tests 251 are plotted as vertical bars on the microseismic density cross section 254. The taller the tracer bar representation is, the better the stimulation of the completion stage is. The tracer results 255 in the area 251 show in general a better response than the tracer response 256 where the strain map 203 shows poor stimulation as indicated by low strain values. This validation step is only included in the workflow in FIG. 5b when properly interpreted microseismicity or any completion stage performance indicator such as tracers are available. If these data are not available, then this step is skipped and the workflow continues to step 159.

Referring again to FIG. 5b, after the strain has been validated against microseismic data, the method continues at step 159 where the strain map 203 is used to estimate the asymmetric half lengths that could be input in hydraulic fracturing design software. Most of the hydraulic fracture treatments are designed with hydraulic fracturing design software that do not take into account the presence of the natural fractures and their impact on the asymmetric behavior of the hydraulic fractures that do not grow the same length from both sides of the wellbore. Referring to FIG. 4, the extent of the hydraulic fracture 121 on each side of the wellbore could have different lengths 131 and 130. These same fracture half-length are usually the result of the hydraulic fracturing design software that unfortunately do not incorporate the effects of the local stress gradients created by the complex interaction between the regional stress and the hydraulic fractures with the natural fractures, the variable geomechanical properties and pore pressure. The results of the disclosed invention available in the strain map 203 could help the hydraulic fracturing design engineer adjust its treatments design. For hydraulic fracturing design software that allow the possibility to have instead of symmetric bi-wings two different half fracture lengths 131 and 130, oriented in any direction instead of being only along the regional stress 117, the extent of the high values of strain shown on strain map 203 around a completion stage could provide the maximum possible lengths 131 and 130 on each side of the wellbore. For example if completion stage 181 has a high differential stress zone south of wellbore, the largest half-lengths 130, 131 could be the distance from the wellbore to the edge of the high strain zone. The orientation of the half fracture length 130 could be oriented along the maximum horizontal stress direction 117. In other instances, the large extent of the strain north of the wellbore allows at stage 186 for the growth of a fracture half-lengths 134 and 135 which represents the distance between the wellbore and the edge of the high strain zone which is farther in the north side than in the south side of completion stage 181.

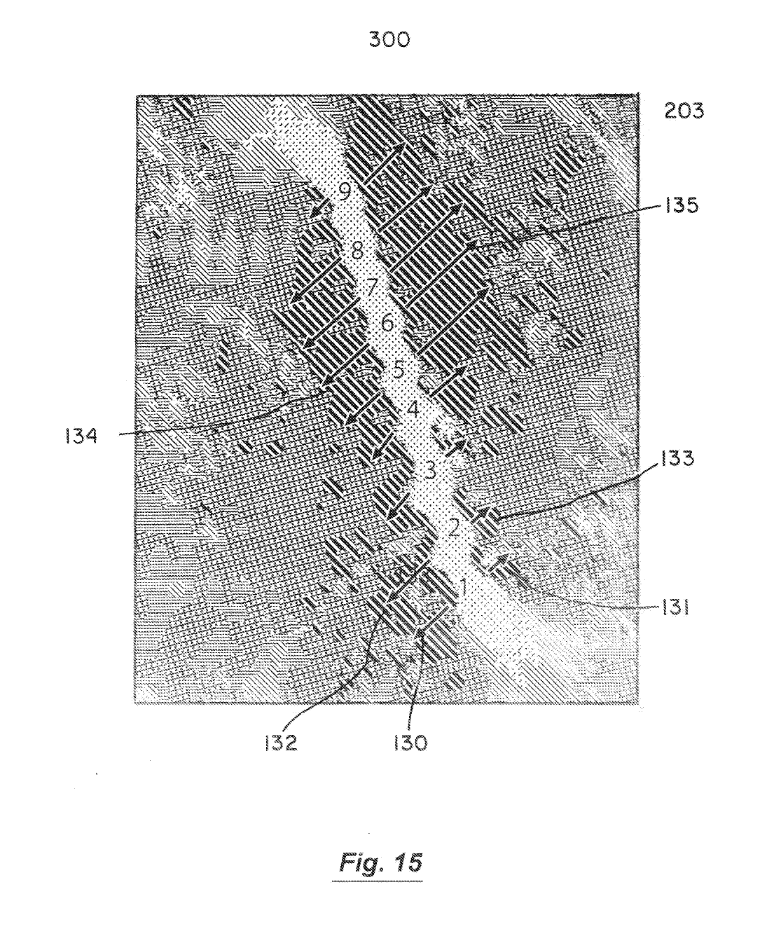

FIG. 14 is a diagram showing the strain around the stimulated well with a cross-section of the same well and the interpreted tracer tests along at nine stimulation stages. FIG. 15 is a diagram showing the strain map along with the interpreted geomechanical asymmetric half lengths for each of nine stimulation stages. These geomechanical half lengths could be estimated for each hydraulic fracturing stage or for each cluster of each stage thus providing a better approximation of the volumetric fracture complexity captured by the volumetric strain.

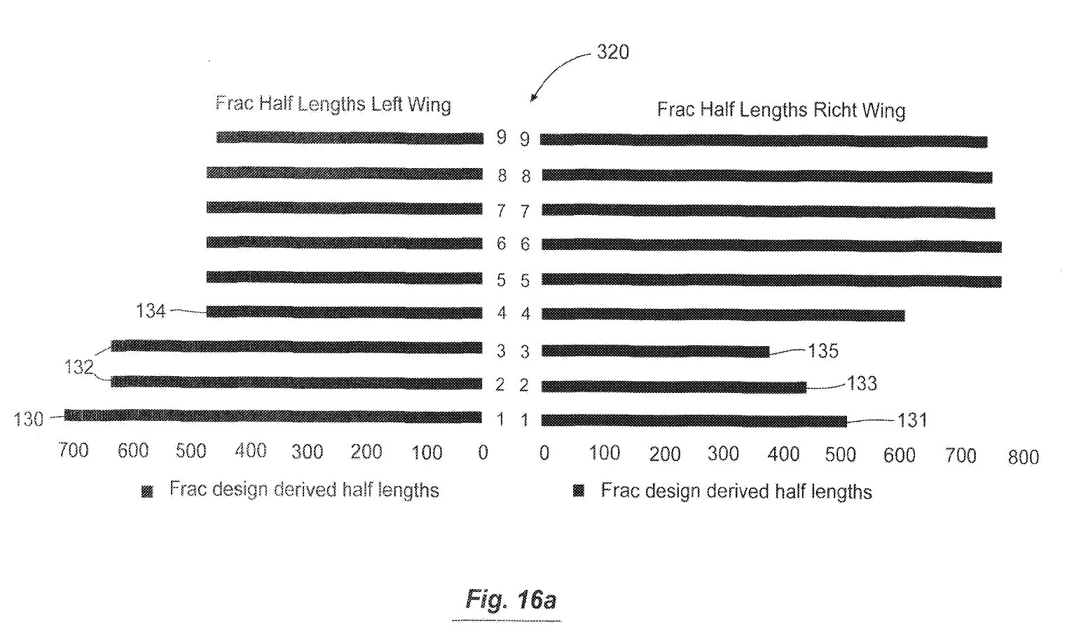

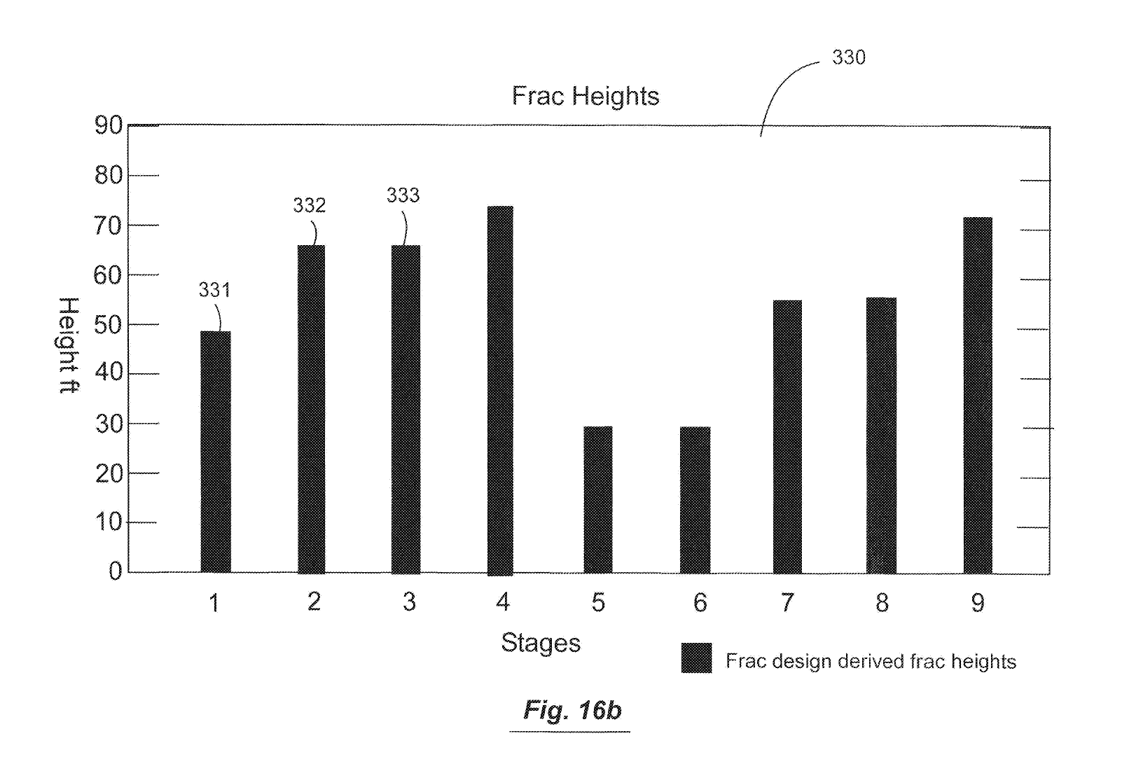

Given the input of maximum half lengths provided by the strain map 203, the hydraulic fracturing design engineer could optimize the design of treating completion stage accordingly by changing some of his design parameters such as leak-off coefficient, stress gradients, proppant concentration or injection rate to not exceed the hydraulic fracture length provided by the present invention. Referring to FIGS. 16a-16b, the hydraulic fracture software that uses the asymmetric half lengths provided by the disclosed invention will provide the modified asymmetric half lengths 320 that will also honor the hydraulic fracturing treatment data, if available. The hydraulic fracture software will provide the optimal values of hydraulic fracture heights 330 where at each completion stage the hydraulic fracture height 331 will vary asymmetrically above and below the well.

The results of the present methodology and the resulting asymmetric half lengths could be used to adjust the treatment of each completion stage to its surrounding geologic and geomechanical environment. The above example shows the results as they pertain to the common process of using the same hydraulic fracturing treatment to all the completion stages independently of their position in the reservoir. The present methodology provides to the completion engineer a means to detect the zones that will require a different treatment due to higher differential stress. The present methodology allows for the optimization of the treatment itself to the surrounding geomechanical environment. By doing so, the success of hydraulic fracturing will be higher at each completion stage

After the strain map has been used to assist with hydraulic fracturing design software that could input variable half-length on each side of the wellbore, the strain map could also in some instances be used as an input to reservoir simulation software. Most of the current reservoir simulation of stimulated unconventional volume assumes the same rectangular area around each hydraulic fracture along the entire wellbore. When microseismic data is available, the stimulated volume used in reservoir simulation is adjusted according to the interpreted microseismic data. Unfortunately, microseismic data is rare in unconventional wells but the present invention could remediate to this shortcoming by providing the potential extent of the stimulated area which is most likely going to be limited to the high strain areas around the wellbore. This can be achieved in two ways. The first one is to simply export the derived asymmetric hydraulic fracture geometry 320 and properties 330 directly to reservoir simulators able to account for planar hydraulic fractures. This approach assumes that the complex reservoir volume stimulated by the hydraulic fracturing is approximated by a collection of mathematical hydraulic fracture planes. In this approach if the large complex reservoir volume is approximated by one planar hydraulic fracture for each stage then the approximation will be most likely poor and will not have enough surface contact to reproduce the correct fluid flow and its impact on the early reservoir pressure which can only be matched with an approximation that uses a fracture plane at each cluster of a hydraulic fracture. The second approach used to provide inputs to reservoir simulator is by simply assuming a relationship between volumetric strain and stimulated permeability.

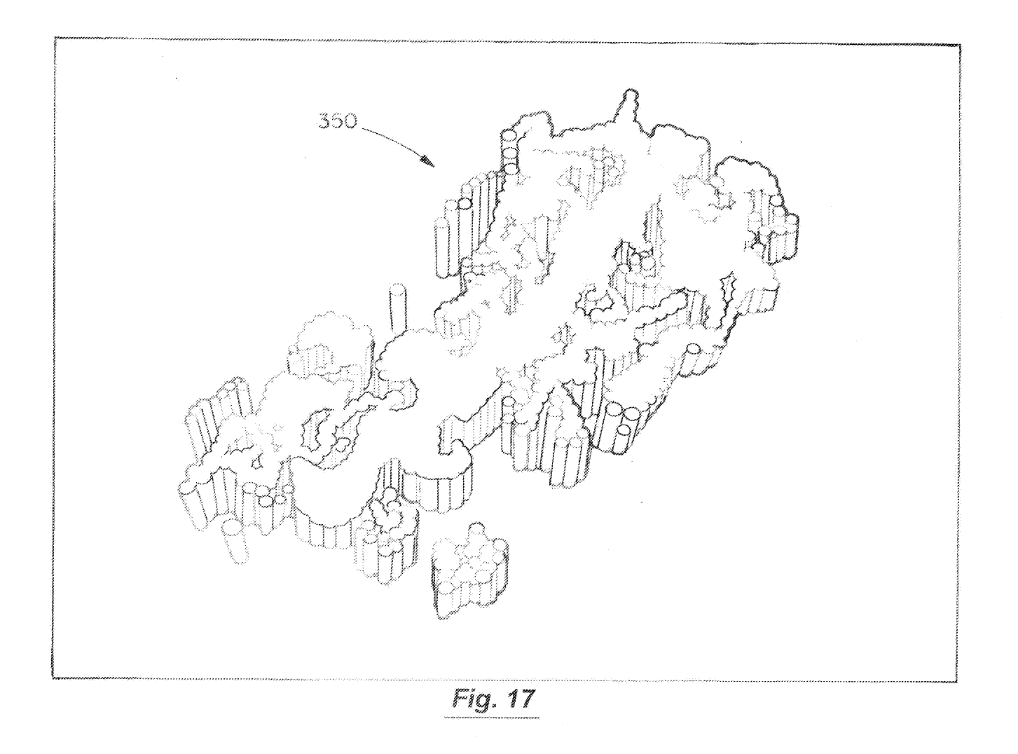

Referring again to FIG. 5b, with the derived strain and hydraulic fracture heights, the method continues at step 160 where the strain map 203 is combined with the asymmetric hydraulic fracture heights to form volumetric strain STR 350 as shown in FIG. 17. The interpolated strain volume will be used as a proxy for the stimulated permeability and input in a reservoir simulator that has assisted history matching capability. The stimulated permeability is assumed to be divided into two distinct regions: (1) Stimulated permeability Kₙₑₐᵣ in the vicinity of the wellbore, and (2) Stimulated permeability in the Stimulated Reservoir Volume (SRV) region, K_{SRV}, within the half lengths derived from the strain map 203, and controlled by the complex interaction between the induced and natural fractures. The stimulated permeability is related to the derived strain volume STR using the following equations:

In the vicinity of the well:

$${K}_{near} = C 1 \cdot [ {( \frac{STR ( r )}{r} )}^{3} ] \qquad Eq . 1 a$$

Inside the Stimulated Reservoir Volume SRV region:

$${K}_{SRV} = C 2 \cdot [ {( \frac{STR ( r )}{r} )}^{2} ] \qquad Eq . 1 b$$

Where Kₙₑₐᵣ is the stimulated permeability in the vicinity of the wellbore, K_{SRV} is the permeability inside the SRV region as delimited by the strain map half lengths, STR is the volumetric strain 350, r is the normalized distance from the wellbore that cannot exceed the variable half lengths, C1 and C2 are two calibration constants which need to be estimated during history matching. The history-matching consists of finding the values of C1 and C2 that match all the well performance data. The present invention provides one type of relationship between volumetric strain and stimulated permeability but multiple other equations could be considered.

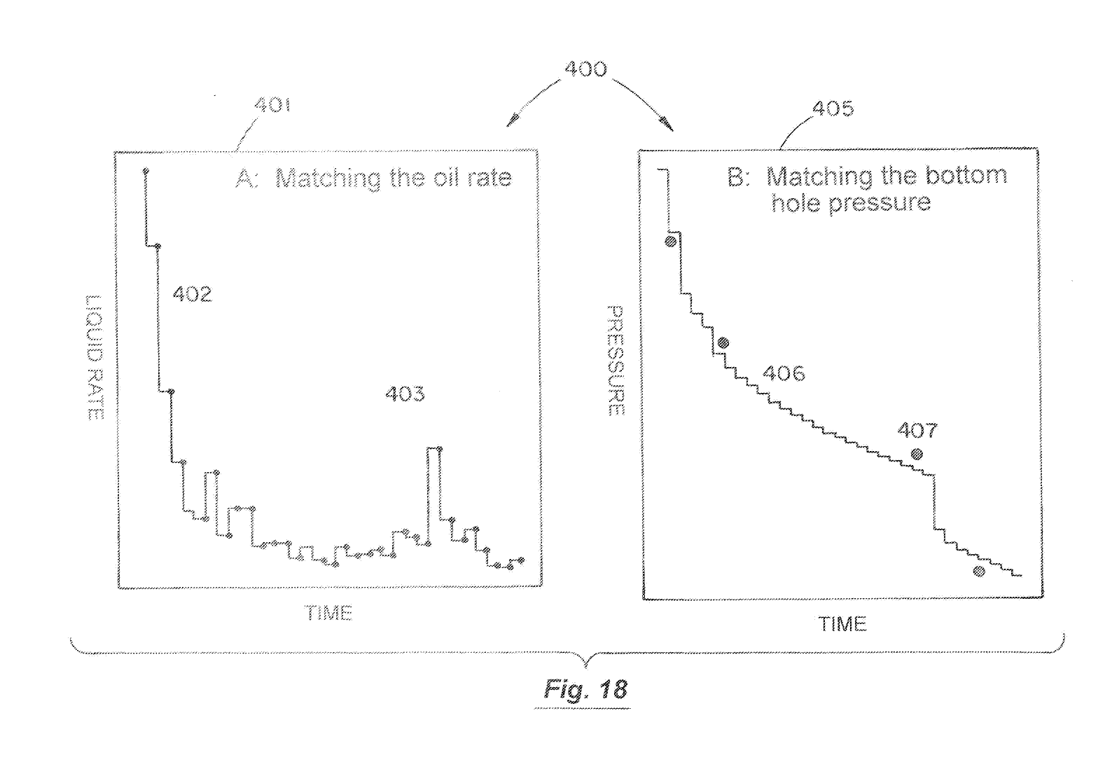

Referring to FIG. 18, the reservoir simulation software is used in the to estimate the two calibrations constants, C1 and C2, by matching the history of produced fluids such as oil rate 401 and pressure 405. The simulated reservoir properties such as pressure 406 will have to match the limited measurements such as pressure 407 in order to derive a satisfactory estimate of the values C1 and C2. In the event of using the first method of exporting directly to reservoir simulators the approximated planar fracture geometries and their properties, it is imperative to use a fracture plane by cluster to match the early pressure in 405 to ensure that the reservoir model captured the correct surface contact created by the hydraulic fracturing. The present invention could be used in conjunction with any reservoir simulator that could handle a reservoir representation as a medium that is single porosity single permeability or dual porosity dual permeability or single porosity dual permeability. The stimulated permeability estimated using the present invention could be as an effective permeability in the single porosity single permeability medium or as a fracture permeability when using a dual permeability medium.

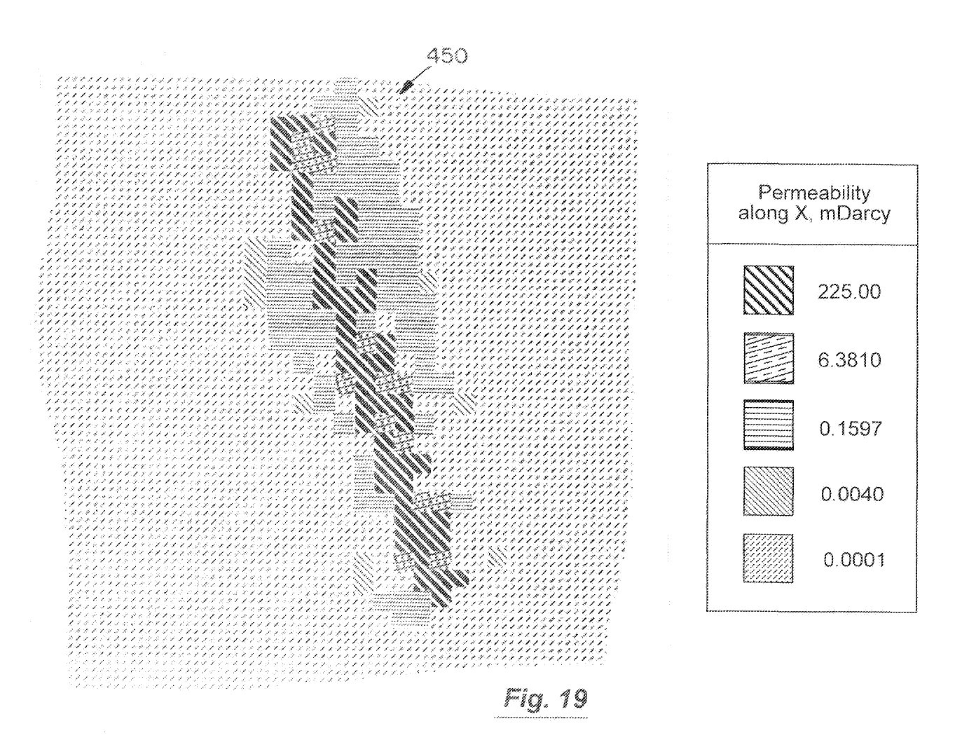

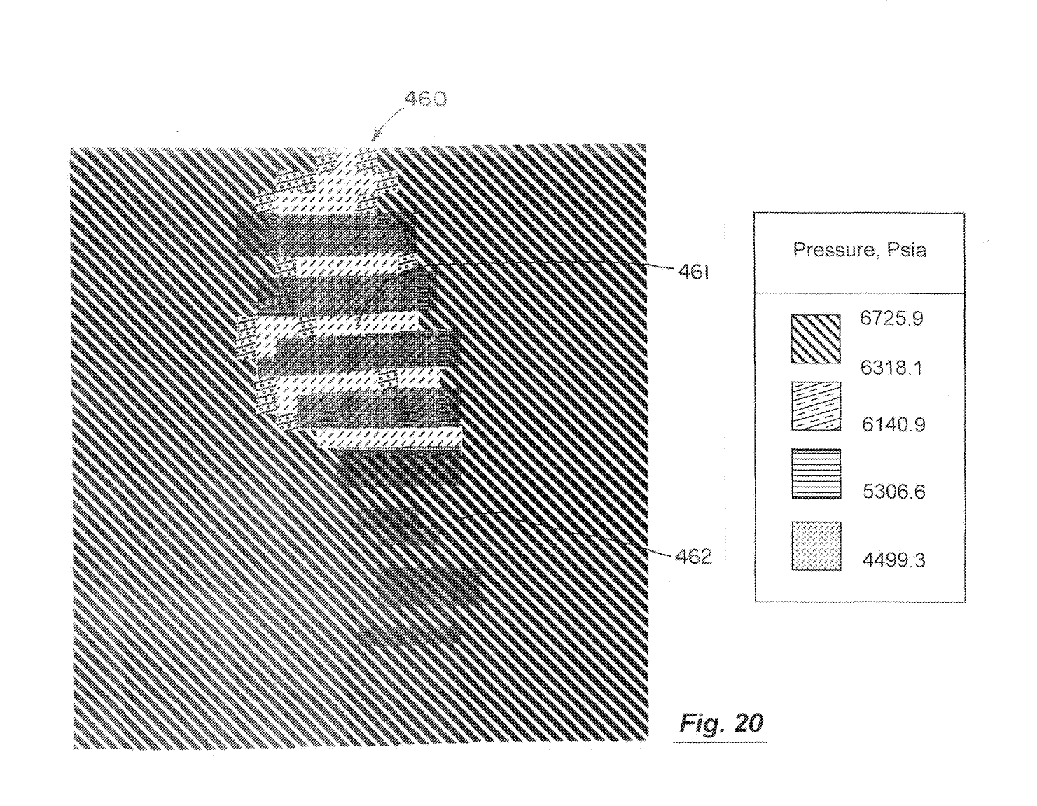

Referring to FIG. 19, when using the volumetric approach of volumetric strain proxy, the resulting stimulated permeability 450 shows high values near the wellbore and a rapid drop when moving away from the wellbore. As a consequence the reservoir simulation predictions of the reservoir pressure 460 at the end of the simulation shown in FIG. 20 reflects also an asymmetric extent that is the result of the asymmetric permeability 450. Some areas 461 show good depletion and a lower reservoir pressure while other areas 462 show a poor depletion and an affected reservoir due to poor hydraulic fracturing that was not adapted to the variable initial geomechanical conditions expressed in the differential stress map 190.

The pressure depletion will result in an accurate estimation of the Estimated Ultimate Recovery (EUR) and will provide a critical information that could be used to optimize well spacing and selection of refracturing candidates. Based on the example shown above, using a constant well spacing in a pad could cause major damages to new wells drilled or hydraulic fractured in depleted zones that extend beyond the expected symmetric zone. Using the present methodology, the refracturing selection process will be very objective and based on the extent of the pressure depletion and the number of completion stages that successfully depleted the reservoir. In the current example, half of the completion stages did not deplete the reservoir. Therefore, the well is considered a good candidate for hydraulic refracturing.

After the strain has been used to assist with hydraulic fracturing design and reservoir simulation software to capture the irregular and variable stimulated volume, it could also be used to provide estimates of the economic impact of each completion design strategy. In some instances, the reduction or increase of completions stages optimized according to their placement only in low differential stress zones could be translated in costs and expenses that could be compared to the revenues generated from the predicted hydrocarbon production derived from reservoir simulation software that also uses the stimulated permeability to simulate the most likely extent of the stimulated reservoir volume that could contribute to the production. Different completion strategies and selection of pad locations, well landing zones, well lengths and azimuths, and choice of number and position of the completion stages based on the strain and the stimulated permeability and the subsequent pressure depletion could be evaluated using an economic criteria such the net present value to allow for the optimal and cost effective design strategy.

The previous discussion provides a number of examples of how the results are applied in the context of the present invention, however no limitation is intended thereby. Rather, it is understood that the present methodology can apply the derived results to a wide array of uses for wells drilled and completed, wells drilled but not completed, and undrilled wells. Accordingly, one of ordinary skill in the art will recognize that extension of the present methodology to other uses of the differential stress, strain, hydraulic fracturing design, stimulated permeability, not explicitly described within this disclosure is within the scope of the present invention.

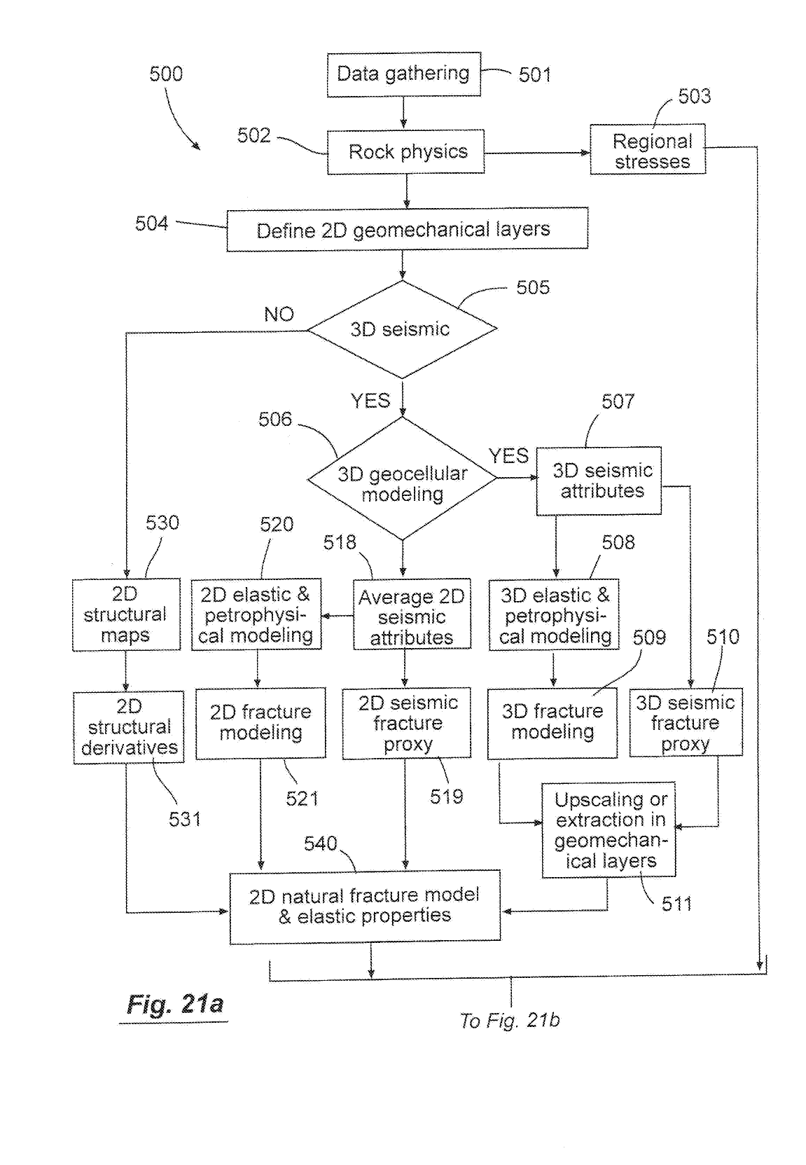

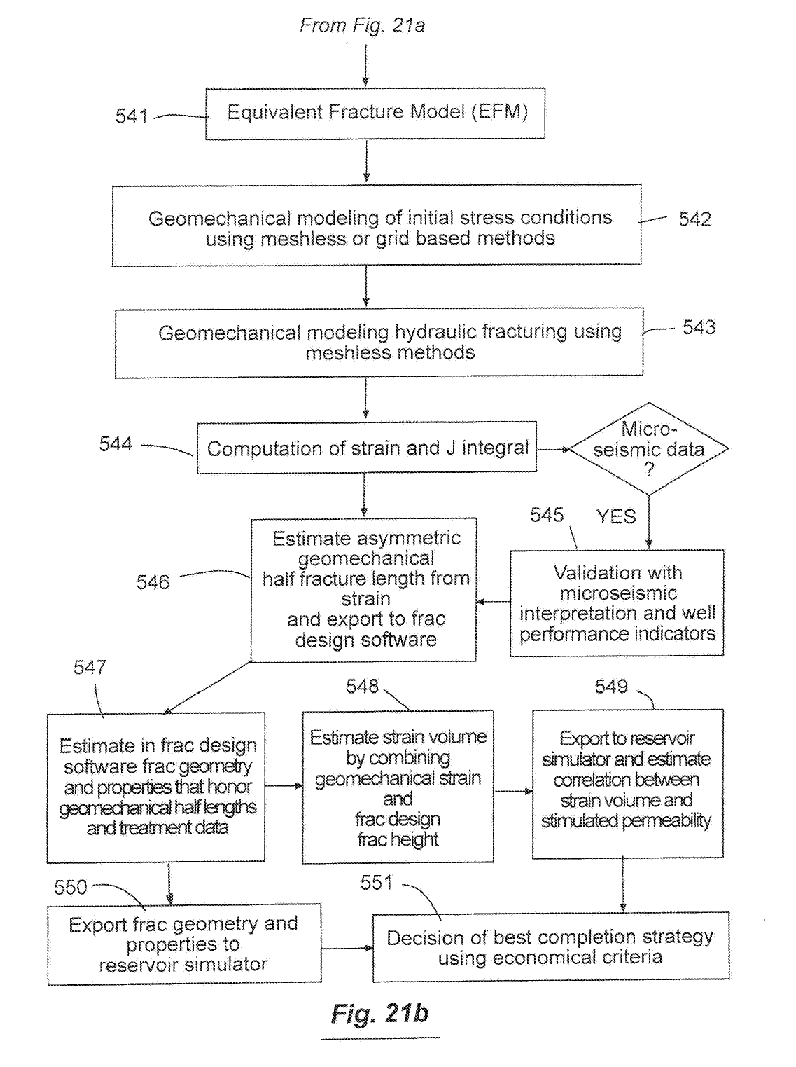

FIGS. 21a-21b are flowcharts of an example of a process for optimizing the design of hydraulic fractures in naturally subterranean fractured reservoirs. Some or all of the operations in this process can be implemented by one or more computing devices. In some implementations, the process may include additional, fewer or different operations performed in the same or different order. Moreover, one or more of the individual operations or subsets of the operations in the process can be performed in isolation or in different contexts to perform one or more of the disclosed techniques. Output data generated by the process, including output generated by intermediate operations, can include stored, displayed, printed, transmitted, communicated or processed information.

At step 501, data are gathered from different sources as shown in step 151 of FIG. 5a. The process starts by applying established rock physics 502 to compute geomechanical properties and pore pressure using the calculated or measured logs available at the gathered wells. Some of the gathered data and rock physics results will be used to estimate regional stress and magnitude 503. The rock physics results 502 will also serve to define a 2D geomechanical layer 504 where all the subsequent calculations will be made to create the 2D maps of differential stress, and strain. If the data gathering step 501 does not include 3D seismic 505, the process will use 2D structural maps 530 to compute structural derivatives (i.e., structural curvatures 531 which will be used as a proxy for the natural fracture 540). If the data gathering step 501 includes 3D seismic 505, the process could be executed using mainly 2D maps without the need for 3D geocellular modeling.

At step 518, the 3D seismic could be used to compute average 2D maps representing average seismic attributes or extractions of 2D seismic maps from existing or computed 3D seismic attributes 518. These 2D seismic attribute extractions or averages could include structural attributes or other types of seismic attributes that could contain information about the natural fractures and could be used directly as a 2D seismic natural fracture proxy 519 which will be considered the 2D natural fracture model. The 2D average or extracted seismic attributes 518 could be used as constraints to build petrophysical and geomechanical models 520 using multiple reservoir modeling techniques that include deterministic, geostatistics, and artificial intelligence methods such as neural networks. The derived 2D elastic and petrophysical properties 520 could be used to derive 2D fracture models 521 using multiple fracturing modeling methods including neural networks that could find the relationship between any natural fracture measure at the wells and the available and derived 2D seismic attributes, petrophysical, and elastic properties.

At step 507, the 3D seismic could be used to compute a multitude of seismic attributes 507 that will serve either as direct 3D seismic fracture proxy 510 or used as guide and constraints to building 3D geomechanical and petrophysical models 508 using multiple reservoir modeling techniques that include deterministic, geostatistics, and artificial intelligence methods such as neural networks. The derived 3D geomechanical and petrophysical properties 508 could be used to derive 3D fracture models 509 using multiple fracturing modeling methods including neural networks that could find the relationship between any natural fracture measure at the wells and the available and derived 3D seismic attributes, petrophysical, and geomechanical properties. The available 3D seismic fracture proxy 510 or derived 3D fracture model constrained by multiple 3D seismic attributes and petrophysical models 508 is either upscaled in the considered geomechanical layer or extracted along a representative interval of the subterranean formation 511 to provide the 2D natural fracture model 540. The 3D elastic properties 508 are also upscaled in the same geomechanical layer or extracted along the same representative interval of the subterranean formation.

At step 540, the 2D natural fracture model available in the geomechanical layer is converted into an equivalent fracture model 541 where each fracture is represented by a length and an orientation both used as input into a meshless particle-based geomechanical simulator 542 able to represent the natural fractures as explicit segments that could be connected or disconnected. After application of the regional stress 117 to the equivalent fracture model 541 and reaching a quasi-equilibrium state, the resulting stress field could be used to compute the differential stress and the local maximum principal stress direction which represents the initial geomechanical conditions required before simulating hydraulic fracturing. At step 543, the simulation of the hydraulic fracturing is accomplished by imposing a pressure derived from the pumping rate to the faces of the hydraulic fractures according to the schedule of the stimulation process. The strain and J integral could be computed at each time step of the simulation of the hydraulic fracturing. The strain and J integral 544 derived at the end of the hydraulic fracturing simulation could be validated with microseismicity or any similar information and hydraulic fracture stage performance indicators if they are available 545. If no validation is possible, then the strain maps could be used in the estimation of asymmetric half lengths 546. Using the estimated geomechanical half lengths, the hydraulic fracturing design software could be constrained to match the treatment data if available and the optimal values of hydraulic fracture heights, leak-off coefficient, stress gradients and other parameters could be optimized. The resulting hydraulic fracture geometry and its properties could be exported directly to reservoir simulators 550. Another way to export the hydraulic fracture results to reservoir simulation is by combining the strain map 544 and the hydraulic fracture heights 547, a volumetric strain volume 548 could be interpolated in three dimensions. The derived volumetric strain volume could be exported to any reservoir simulator 549 where an assumption could be made as the possible relationship that could exist between the derived volumetric strain and the stimulated permeability. When assuming an analytic expression between the volumetric strain and the stimulated permeability, the history matching of well performance will allow the estimation of the parameters used to describe the relationship between the strain volume and the stimulated permeability. The final dynamic model derived in the reservoir simulator will provide the overall performance of the well including its ultimate production and the extent of the pressure depletion around it. Given the differential stress, fracture heights derived in the hydraulic fracturing design software and the pressure depletion derived in the reservoir simulation software, multiple completion optimization strategies could be investigated and what if scenarios undertaken. All these different strategies could be evaluated economically (step 551).

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for optimizing hydraulic fracturing by simulating the geomechanical interaction between regional stress and natural fractures in a reservoir, said method comprising:
creating an equivalent fracture model in which points in the reservoir have a fracture length and fracture orientation;
simulating the geomechanical interaction between regional stress and natural fractures in the reservoir by a meshless particle-based method using the equivalent fracture model as an input to estimate stress at points in the reservoir prior to hydraulic fracturing;
simulating the geomechanical interaction between hydraulic fractures and natural fractures in the reservoir during hydraulic fracturing by a meshless particle-based method using the stress data as inputs to estimate strain at points in the reservoir;
estimating an approximation of the volumetric strain by planar asymmetric hydraulic fractures;
estimating stimulated permeability at points in the reservoir based at least in part from the strain data or the approximated planar asymmetric hydraulic fractures;
simulating the estimate ultimate recovery from wells in the reservoir based at least in part from the stimulated permeability data; and
optimizing wellbore and completion stage positions in the reservoir based at least in part on the estimated ultimate recovery.

2. The method of claim 1 wherein the stress estimated by the meshless particle-based method comprises the horizontal differential stress and maximum principal stress direction at points in the reservoir.

3. The method of claim 1 wherein the equivalent fracture model is created at least in part from data on the natural fracture density, regional stress, geomechanical properties and pore pressure of the reservoir.

4. The method of claim 1 wherein the step of simulating hydraulic fracturing further comprises estimating the J integral at points in the reservoir.

5. The method of claim 1 further comprising the step of validating the stress data against production data from wells in the reservoir.

6. The method of claim 1 further comprising the step of validating the strain data against microseismic data for the reservoir.

7. The method of claim 1 further comprising the following steps prior to estimating the stimulated permeability:
estimating asymmetric half fracture lengths at points in the reservoir from the strain data; and
estimating hydraulic fracture heights and flow properties from the asymmetric half fracture lengths and strain data; and
wherein the step of estimating the stimulated permeability is based at least in part from the hydraulic fracture heights, fracture flow properties, and strain data.

8. The method of claim 1 wherein the step of optimizing wellbore and completion stage positions in the reservoir further comprises simulating pressure depletion in the reservoir adjacent to a wellbore based at least in part on stimulated permeability.

9. A method for optimizing hydraulic fracturing by simulating the geomechanical interaction between regional stress and natural fractures in a reservoir, said method comprising:
creating an equivalent fracture model from data on the natural fracture density, regional stress, geomechanical properties, and pore pressure of the reservoir, in which points in the reservoir have a fracture length and fracture orientation;
simulating the geomechanical interaction between regional stress and natural fractures in the reservoir prior to hydraulic fracturing by a meshless particle-based method using the equivalent fracture model as an input to estimate the horizontal differential stress and maximum principal stress direction at points in the reservoir;
simulating the geomechanical interaction between hydraulic fractures and natural fractures in the reservoir during hydraulic fracturing by a meshless particle-based method using the horizontal differential stress and maximum principal stress direction data as inputs to estimate strain at points in the reservoir;
estimating stimulated permeability at points in the reservoir based at least in part from the strain data;
simulating the estimate ultimate recovery from wells in the reservoir based at least in part from the stimulated permeability data; and
optimizing wellbore and completion stage positions in the reservoir based at least in part on the estimated ultimate recovery.

10. The method of claim 9 wherein the step of simulating hydraulic fracturing further comprises estimating the J integral at points in the reservoir.

11. The method of claim 9 further comprising the step of validating the horizontal differential stress data against production data from wells in the reservoir.

12. The method of claim 9 further comprising the step of validating the strain data against microseismic data for the reservoir.

13. The method of claim 9 further comprising the following steps prior to estimating the stimulated permeability:
estimating asymmetric half fracture lengths at points in the reservoir from the strain data; and
estimating hydraulic fracture heights, and fracture flow properties from the asymmetric half fracture lengths and strain data; and
wherein the step of estimating the stimulated permeability is based at least in part from the hydraulic fracture heights and strain data.

14. The method of claim 9 wherein the step of optimizing wellbore and completion stage positions in the reservoir further comprises simulating pressure depletion in the reservoir adjacent to a wellbore based at least in part on stimulated permeability.

15. A method for optimizing hydraulic fracturing by simulating the geomechanical interaction between regional stress and natural fractures in a reservoir, said method comprising:
creating an equivalent fracture model from data on the natural fracture density, regional stress and elastic properties of the reservoir, in which points in the reservoir have a fracture length and fracture orientation;
simulating the geomechanical interaction between regional stress and natural fractures in the reservoir prior to hydraulic fracturing by a meshless particle-based method using the equivalent fracture model as an input to estimate the horizontal differential stress and maximum principal stress direction at points in the reservoir;
simulating the geomechanical interaction between hydraulic fractures and natural fractures in the reservoir during hydraulic fracturing by a meshless particle-based method using the horizontal differential stress and maximum principal stress direction data as inputs to estimate strain at points in the reservoir;
estimating asymmetric half fracture lengths at points in the reservoir from the strain data;
estimating hydraulic fracture heights and fracture flow properties from the asymmetric half fracture lengths and strain data;
estimating stimulated permeability at points in the reservoir based at least in part from the hydraulic fracture heights, fracture flow properties and strain data;
simulating the estimate ultimate recovery from wells in the reservoir based at least in part from the stimulated permeability data; and
optimizing wellbore and completion stage positions in the reservoir based at least in part on the estimated ultimate recovery.

16. The method of claim 15 wherein the step of simulating hydraulic fracturing further comprises estimating the J integral at points in the reservoir.

17. The method of claim 15 further comprising the step of validating the horizontal differential stress data against measured data from wells in the reservoir.

18. The method of claim 15 further comprising the step of validating the strain data against microseismic data for the reservoir.

19. The method of claim 15 wherein the step of optimizing wellbore and completion stage positions in the reservoir further comprises simulating pressure depletion in the reservoir adjacent to a wellbore based at least in part on stimulated permeability.
